(19) United States
(12) Patent Application Publication
(10) Pub. No.: US 2017/0026282 A1
(43) Pub. Date: Jan. 26, 2017

(54) Configuration of Data Path Groups in Wireless Networks

(71) Applicant: Intel IP Corporation, Santa Clara, CA (US)

(72) Inventors: Po-Kai Huang, Santa Clara, CA (US); Emily H. Qi, Camas, WA (US)

(21) Appl. No.: 14/998,210

(22) Filed: Dec. 26, 2015

Related U.S. Application Data
(60) Provisional application No. 62/195,197, filed on Jul. 21, 2015.

(51) Int. Cl. H04L 12/715; H04W 40/24; H04W 8/00; H04L 12/733

(52) U.S. Cl. CPC H04L 45/46; H04L 45/122; H04W 40/248; H04W 8/005

(57) ABSTRACT

Configuration of data path groups in wireless networks is provided. Configuration includes generation and/or removal of data path groups, and can leverage a hop count between a device to be added to the data path group and a defined device within the data path group. By limiting a permitted maximum hop count within a data path group, a mechanism that contains the size of a data path group can be implemented. In some embodiments, the data path group can be embodied in or can include a neighbor awareness networking (NAN) data path group formed within (or, in some instances, logically on top of) a cluster of NAN devices.

### CROSS-REFERENCE TO RELATED PATENT APPLICATION

The present application is related to and claims priority from U.S. Provisional Patent Application No. 62/195,197, filed Jul. 21, 2015, which application is hereby incorporated by reference herein in its entirety.

### BACKGROUND

Wi-Fi Aware™ is a specification of protocols for devices that operate according to the Wi-Fi family of standards to enable device and/or service discovery in their proximity. In some aspects, Wi-Fi Aware™ can permit the formation of a cluster for devices in proximity, where the devices in the cluster can follow a common awake time schedule, generally referred to as discovery window, in order to permit cluster formation or expansion, and to achieve low power operation.

### BRIEF DESCRIPTION OF THE DRAWINGS

The accompanying drawings form an integral part of the disclosure and are incorporated into the present specification. The drawings illustrate example embodiments of the disclosure and, in conjunction with the description and claims, serve to explain at least in part various principles, features, or aspects of the disclosure. Certain embodiments of the disclosure are described more fully below with reference to the accompanying drawings. However, various aspects of the disclosure can be implemented in many different forms and should not be construed as limited to the implementations set forth herein. Like numbers refer to like elements throughout.

FIG. 1 presents an example of an operational environment for wireless communication in accordance with one or more embodiments of the disclosure.

FIG. 2 presents another example of an operational environment for wireless communication in accordance with or more embodiments of the disclosure.

FIG. 3 presents an example of a network environment in accordance with one or more embodiments of the disclosure.

FIG. 4A presents an example of a cluster of devices having data path groups configured in accordance with one or more embodiments of the disclosure.

FIG. 4B presents other examples of clusters of devices having data path groups configured in accordance with one or more embodiments of the disclosure.

FIG. 5A presents an example of a device in accordance with one or more embodiments of the disclosure.

FIG. 5B presents an example of a radio unit for wireless communication in accordance with one or more embodiments of the disclosure.

FIG. 6 presents another example of a device in accordance with one or more embodiments of the disclosure.

FIG. 7 presents an example of an attribute associated with configuration of a data group in accordance with one or more embodiments of the disclosure.

FIG. 8 presents an example of a computational environment for wireless communication in accordance with one or more embodiments of the disclosure.

FIG. 9 presents another example of a device for wireless communication in accordance with one or more embodiments of the disclosure

FIGS. 10-11 present examples of methods for configuring data path groups according to one or more embodiments of the disclosure.

### DETAILED DESCRIPTION

The disclosure recognizes and addresses, in at least certain embodiments, the issue of expansion of a cluster of devices in a low-power wireless network, and the ensuing increase of signaling associated with various functions of such a cluster of devices. Numerous low-power wireless networks having network elements communicating wirelessly or otherwise. An example of such networks is a Thread network, which embodies a mesh network that operates according to Thread protocols. Specifically, Thread is a new mesh network communications standard that is undergoing definition in the Thread Group with an initial, non-limiting focus on the smart home market. The Thread Physical layer operates in the 2.4 GHz frequency band and is based on IEEE 802.15.4 PHY and MAC specification. Another example of a low-power network is mesh network that operates according to Wi-Fi Aware™, which also may be referred to as neighbor awareness networking (NAN). Such a mesh network can be referred to as a NAN wireless network. Clusters of devices can be formed in a NAN wireless network, where a device in a cluster can discover devices and/or services according to a common awake-time scheduled (e.g. a discovery window). More specifically, devices in a cluster can be synchronized to a same clock, and can converge on a time interval (e.g., a discovery window) and communication channel in order to permit the discovery of each other's services. In addition, a NAN data cluster (NDC) having data paths and/or data links can be formed (e.g., defined logically) on top of an existing NAN cluster. Devices that pertain to an NDC also can have a common base schedule for device and/or service discovery, e.g., a discovery window or another type of awake-time schedule. In some scenarios, each (or, in some instances, at least one) device in an NDC can have dynamic resources constraints, which can preclude or otherwise make difficult a common base schedule. Further or in other scenarios, the common base schedule can be updated in order to accommodate such constraints. The signaling associated with such updates increases with the size of an NDC.

As described in greater detail below, the disclosure provides, among other things, devices, systems, techniques, and/or computer program products for configuration of data path groups in a low-power wireless network. At least some embodiments of the devices, systems, techniques, computer program products of the disclosure can provide mechanisms for data path setup and tear-down in a low-power network (wireless or otherwise). Such embodiments or other embodiments of devices, systems, techniques, computer programs products of the disclosure can provide mechanisms to contain the expansion (e.g., to limit the size) of data path groups in the low-power network. In some implementations, the mechanisms can leverage a hop count between a device to be added to a data path group (or, in some examples, a data cluster) and a defined or otherwise specific device within the data path group. By limiting a permitted maximum hop count within a data path group, a mechanism that contains the size of a data path group can be implemented. According to one or more embodiments of the disclosure, signaling and/or constraints related to hop count include various messaging amongst devices in the data path group. In some embodiments, a data path group can be embodied in or can include a neighbor awareness networking (NAN) data cluster (NDC) formed within (or, in some instances, logically on top of) a cluster of NAN devices.

While various embodiments of the disclosure are illustrated in connection with a network that operates according to Tread network protocols, it is noted that disclosure is not limited in this respect and embodiments of the disclosure can be implemented in any low-power network having devices that operate at low power and can transition between a power-sleep mode (or low-power mode) to a power-awake mode (or high-power mode) during operation within the network. Further, the elements described herein in connection with configuration of data path groups can be implemented in any type of wireless networks (low-power or otherwise) operating according to any radio technology protocols for wireless communication, not just Thread protocols or NAN protocols. Embodiments described herein can provide systems, methods, and devices, for signaling information to Wi-Fi devices in various Wi-Fi networks, including Wi-Fi Aware™, also referred to as neighbor awareness networking (NAN) network.

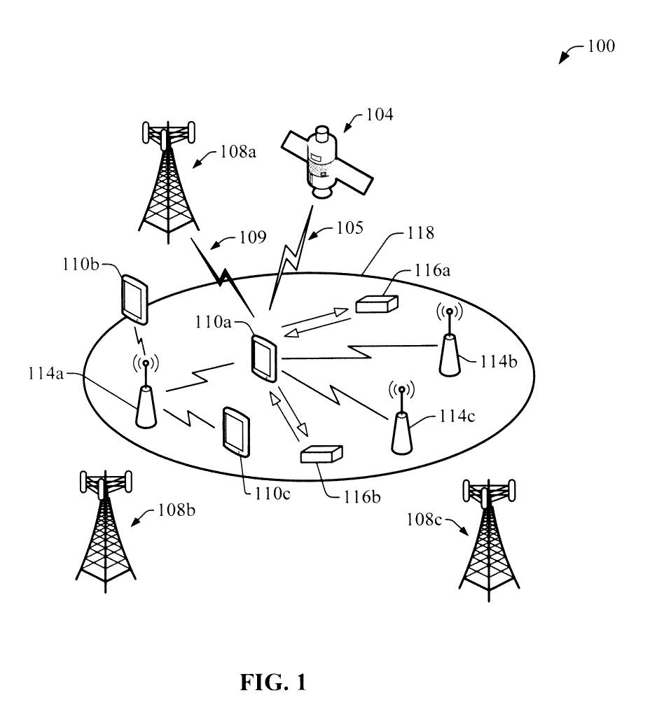

With reference to the drawings, FIG. 1 presents a block diagram of an example operational environment 100 for wireless communication in accordance with at least certain aspects of the disclosure. The operational environment 100 includes several telecommunication infrastructures and communication devices, which collectively can embody or otherwise constitute a telecommunication environment. More specifically, yet not exclusively, the telecommunication infrastructures can include a satellite system 104. As described herein, the satellite system 104 can be embodied in or can include a global navigation satellite system (GNSS), such as the Global Positioning System (GPS), Galileo, GLONASS (Globalnaya navigatsionnaya sputnikovaya sistema), BeiDou Navigation Satellite System (BDS), and/or the Quasi-Zenith Satellite System (QZSS). In addition, the telecommunication infrastructures can include a macro-cellular or large-cell system; which is represented with three base stations 108a-108c; a micro-cellular or small-cell system, which is represented with three access points (or low-power base stations) 114a-114c; and a sensor-based system—which can include proximity sensor(s), beacon device(s), pseudo-stationary device(s), and/or wearable device(s)—represented with functional elements 116a-116c. As illustrated, in one implementation, each of the transmitter(s), receiver(s), and/or transceiver(s) included in respective computing devices (such as telecommunication infrastructure) can be functionally coupled (e.g., communicatively or otherwise operationally coupled) with the wireless device 110a (also referred to as communication device 110a) via wireless link(s) in accordance with specific radio technology protocols (e.g., IEEE 802.11a, IEEE 802.1 lax, etc.) in accordance with aspects of this disclosure. For another example, a base station (e.g., base station 108a) can be functionally coupled to the wireless devices 110a, 110b, and 110c via respective an upstream wireless link (UL) and a downstream link (DL) configured in accordance with a radio technology protocol for macro-cellular wireless communication (e.g., 3^{rd} Generation Partnership Project (3GPP) Universal Mobile Telecommunication System (UMTS) or “3G,” “3G”; 3GPP Long Term Evolution (LTE), or LTE); LTE Advanced (LTE-A)). For yet another example, an access point (e.g., access point (AP) device 114a) can be functionally coupled to one or more of the wireless devices 110a, 110b, or 110c via a respective UL and DL configured in accordance with a radio technology protocol for small-cell wireless communication (e.g., femtocell protocols, Wi-Fi, and the like). For still another example, a beacon device (e.g., device 116a) can be functionally coupled to the wireless device 110a with a UL-only (ULO), a DL-only, or an UL and DL, each of such wireless links (represented with open-head arrows) can be configured in accordance with a radio technology protocol for point-to-point or short-range wireless communication (e.g., ZigBee®, Bluetooth®, or near field communication (NFC) standards, ultrasonic communication protocols, or the like).

In the operational environment 100, the small-cell system and/or the beacon devices can be contained in a confined area 118 that can include an indoor region (e.g., a commercial facility, such as a shopping mall) and/or a spatially-confined outdoor region (such as an open or semi-open parking lot or garage). The small-cell system and/or the beacon devices can provide wireless service to a device (e.g., wireless device 110a or 110b) within the confined area 118. For instance, the wireless device 110a can handover from macro-cellular wireless service to wireless service provided by the small-cell system present within the confined area 118. Similarly, in certain scenarios, the macro-cellular system can provide wireless service to a device (e.g., the wireless device 110a) within the confined area 118.

In certain embodiments, the wireless device 110a, as well as other communication devices (wireless or wireline) contemplated in the present disclosure, can include electronic devices having computational resources, including processing resources (e.g., processor(s)), memory resources (memory devices (also referred to as memory), and communication resources for exchange of information within the computing device and/or with other computing devices. Such resources can have different levels of architectural complexity depending on specific device functionality. Exchange of information among computing devices in accordance with aspects of the disclosure can be performed wirelessly as described herein, and thus, in one aspect, the wireless device 110a also can be referred to as wireless communication device 110a, wireless computing device 110a, communication device 110a, or computing device 110a interchangeably. The same nomenclature considerations apply to wireless device 110b and wireless device 110c. More generally, in the present disclosure, a communication device can be referred to as a computing device and, in certain instances, the terminology “communication device” can be used interchangeably with the terminology “computing device,” unless context clearly dictates that a distinction should be made. In addition, a communication device (e.g., communication device 110a or 110b or 110c) that operates according to HEW can utilize or leverage a physical layer convergence protocol (PLCP) and related PLCP protocol data units (PPDUs) in order to transmit and/or receive wireless communications. Example of the computing devices that can communicate wirelessly in accordance with aspects of the present disclosure can include desktop computers with wireless communication resources; mobile computers, such as tablet computers, smartphones, notebook computers, laptop computers with wireless communication resources, Ultrabook™ computers; gaming consoles, mobile telephones; blade computers; programmable logic controllers; near field communication devices; customer premises equipment with wireless communication resources, such as set-top boxes, wireless router devices, wireless-enabled television sets, or the like; and so forth. The wireless communication resources can include radio units (also referred to as radios) having circuitry for processing of wireless signals, processor(s), memory device(s), and the like, where the radio, the processor(s), and the memory device(s) can be coupled via a bus architecture.

The computing devices included in the example operational environment 100, as well as other computing devices contemplated in the present disclosure, can implement channel update of a sleepy-end device (SED), as described herein. It is noted that other functional elements (e.g., server devices, router devices, gateway devices, and the like) can be included in the operational environment 100. It is also noted that the aspects of configuration of data path groups disclosed in this disclosure can be implemented in any telecommunication environment including a wireline network (e.g., a cable network, an internet-protocol (IP) network, an industrial control network, any wide area network (WAN), a local area network (LAN), a personal area network (PAN), a home area network (HAN) (such as a sensor-based network) or the like); a wireless network (e.g., a cellular network (either small-cell network or macro-cell network), a wireless WAN (WWAN), a wireless LAN (WLAN), a wireless PAN (WPAN), a wireless HAN, such as a wireless sensor-based network, a satellite network, or the like); a combination thereof; or the like.

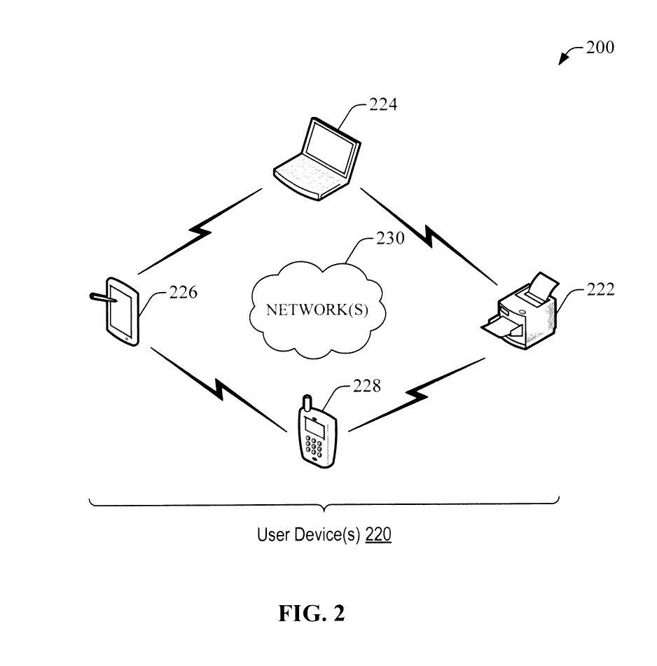

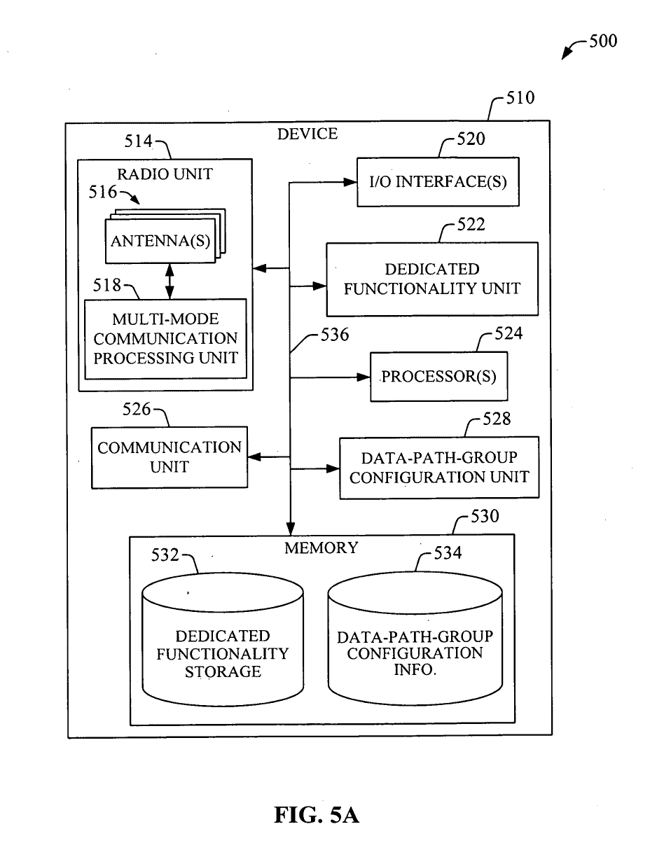

FIG. 2 illustrates an example of an operational environment 200 in accordance with one or more embodiments of the disclosure. The exemplified operational environment 200 can include one or more user devices 220, each (or in some embodiments, at least one) of the user devices 220 can communicate wirelessly (e.g., can transmit and/or can receive wireless signal) in accordance with wireless standards, such as the IEEE 802.11 communication standards. For example, two or more of the user devices 220 can perform connectivity procedures with one another in order to set up Wi-Fi data sessions, according to some embodiments of the present disclosure. As illustrated in FIG. 2, the user devices 220 can include a device 122, a device 124, a device 126, and/or a device 128), wherein each (or, in some embodiments, at least one) of the user device(s) 220 can be a wireless device that is non-stationary, without an established fixed location. In some aspects, a wireless communication channel can be established between two or more wireless devices (e.g., user device(s) 120). In some embodiments, at least one of the user devices 220 can be embodied in or can include one or more of the devices shown in one of FIGS. 5A, 6, 8, and 9.

Each or, in some embodiments, at least one of the user devices 220 (e.g., 124, 126, or 128) can be embodied in or can include any suitable processor-driven user device, such as a desktop user device, a laptop user device, a server device, a router device, a switch device, an access point device, a smartphone, a tablet device, a wearable wireless device (e.g., a wristband, a watch, glasses, and so forth), and combination of the foregoing, or the like.

Any of the user device(s) 220 (e.g., device 222, device 224, device 226, and/or device 228) can be configured to communicate with each other wirelessly or otherwise via, for example, one or more communications networks 230. The communications network(s) 230 can include any one of a combination of different types of suitable communications networks, such as broadcasting networks, cable networks, public networks (e.g., the Internet), private networks, wireless networks, cellular networks, or any other suitable private and/or public networks. Further, communications network(s) 230 can have any suitable communication range associated therewith and can include global networks (e.g., the Internet), metropolitan area networks (MANs), wide area networks (WANs), local area networks (LANs), or personal area networks (PANs). In addition, communications network 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 220 can include one or more communications antennas. A communications antenna can be embodied in or can include any suitable type of antenna corresponding to the communications protocols used by the user device(s) 220. Examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antennas can be communicatively coupled to a radio component to transmit and/or receive wireless signals, such as communications signals to and/or one or more of the user devices 220.

Any of the user devices 220 can include any suitable radio unit and/or transceiver for transmitting and/or receiving radio frequency (RF) signals in the bandwidth and/or channels corresponding to the communications protocols utilized by any of the user device(s) 220 in order to communicate with each other. The radio unit can include hardware and/or software to modulate and/or demodulate communications signals according to defined transmission protocols. The radio components may further have hardware and/or software instructions to communicate via one or more Wi-Fi and/or Wi-Fi direct protocols, as standardized by the IEEE 802.11 standards. In some embodiments, the radio unit, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth®, ZigBee®, dedicated short-range communication (DSRC), Ultra-High Frequency (UHF) (e.g. IEEE 802.11af, IEEE 802.22), white band frequency (e.g., white spaces), or other packetized radio communications. The radio unit can include any known receiver and baseband processor (or, in some embodiments, baseband processing circuitry) to communicate via the communications protocols. The radio unit can further include a low noise amplifier (LNA), additional signal amplifiers, an analog-to-digital (A/D) converter, one or more buffers, and digital baseband processing circuitry:

As mentioned, embodiments of this disclosure can permit configuration of data path groups in a wireless network, such as a low-power wireless network. To that end, in some aspects, a transmitter device (e.g., user device 224) and a receiver device (e.g., user device 226) can exchange capability information via, for example, the exchange of service discovery frames.

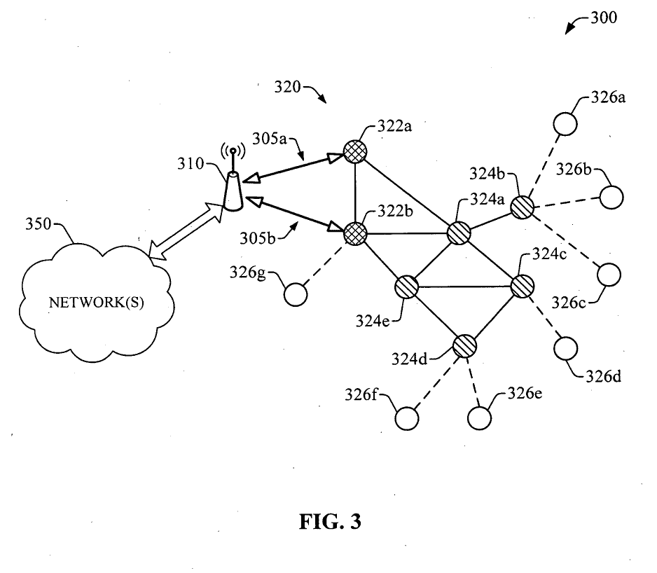

FIG. 3 illustrates an example of an operational environment 300 in accordance with one or more embodiments of the disclosure. The operational environment 300 includes a mesh network 320 having devices that can operate according to Thread protocols and/or any other communication protocols suitable for, among other things, IP-based communication (e.g., IPv6 protocol), low-power, secure, low-latency (e.g., less than about 100 ms) and/or scalable operation of the devices (e.g., smartphones, tablet computers, appliances, sensors, locks, and the like). The devices can include, in some embodiments; appliances; devices for access control (e.g., locks); devices for climate control (e.g., temperature sensors, heaters, refrigeration devices, etc.); devices for energy management; lamps, light bulbs, or other type of devices for lightning; devices for safety (e.g., cameras) and or other types of security (e.g., alarms). Some of the devices can be powered via a conventional power grid, other devices can be powered via a combination between power grid and battery or other type of energy storage, and yet other devices can be powered via batteries or elements for energy harvesting. At least some of the devices included in the mesh network 320 also can communicate according to other protocols, such as Wi-Fi protocols, beyond Thread protocols or NAN protocols. In some implementations, the mesh network 320 is functionally coupled to an AP device 310 that permits functional coupling with one or more external networks 350 (such as the Internet or another type of WAN/WWAN). One or more devices within the mesh network 320 can permit functional coupling between the mesh network 320 and the AP device 310, each of the one or more devices can be referred to as border router device (or border router). In some embodiments, Wi-Fi wireless links can permit exchange of information between the AP device 320 and the one or more border routers. In other embodiments, other types of wireless links (e.g., femtocell wireless links) or wireline links (e.g., Ethernet links) can permit communication between the one or more border router devices and the AP device 310. As illustrated, in the operational environment 300, border routers 322a and 322b can be functionally coupled to AP device 310 via Wi-Fi links 305a and 305b, respectively. A border router can be functionally coupled to one or more devices within the mesh network 320, at least one of the devices coupled to the border router can be referred to as a router node or router device. Other device(s) coupled to the border router can be a leaf node (e.g., a SED). Border router devices can provide services, such as routing services for off-network operations, for devices within the mesh network 320.

A router device can provide routing services to devices within the mesh network 320. In addition or in the alternative, a router device can provide joining services and/or security services for a device that attempts to join the mesh network 320. As opposed to SEDs, a router is not configured to enter a power-off mode or other type of low-power state. The exemplified operational environment includes five router devices 324a-324d. In some embodiments, border router devices and router devices can exchange information according to Thread protocols. In one example, wireless links pertaining to a Thread WPAN (such as 6Lo links) can permit communication of network data and/or network signaling between such devices. Such links are represented as solid lines in FIG. 3.

In addition, a router device (e.g., router device 324b) can be coupled to one or more leaf nodes (or leaf devices) within the mesh network 320. In one implementation, a lead node can be referred to as a SED. A leaf node (or SED) can be embodied in or can include a host device, and can communicate via a parent router device associated with the lead node. As such, the leaf node cannot forward messages to another lead node. The illustrated operational environment 300 includes seven leaf nodes 326a-326g. In some embodiments, wireless links pertaining to a Thread WPAN (such as 6Lo Sleepy links) can permit communication of network data and/or network signaling between a router device and a leaf node. Such wireless links are represented with dashed lines in FIG. 3. A leaf node (or SED) can be powered via a battery or other type of energy storage and supply device. In addition or in some embodiments, a leaf node can be powered via a device that permits harvesting energy (e.g., a solar panel, a turbine, geothermal energy conversion devices, etc.). Leaf nodes can include one or more of thermostats; light switches; smoke detectors; carbon monoxide detectors; display devices; door bells; intrusion sensors; automated cleaning devices; door sensors or other type of presence sensors; actuation sensors (e.g., window, door, etc.); motion sensors; door locks; radiator valves; biometric devices; fans; smart plugs; smart meters or other types of dosimeter devices; appliances; heating, ventilation, and air conditioning (HVAC) equipment; a combination of the foregoing, or the like.

As mentioned, embodiments of the disclosure can permit configuration of data path groups (e.g., NDC data clusters) in wireless networks, including generation of data path groups and/or removal of other data path groups. More specifically, some embodiments for configuration of a data path group can leverage a hop count between a device to be added to the data path group and a defined device within the data path group. Hop count can correspond to the number of intervening devices between the device to be added and the reference device, where the intervening devices have a respective data link amongst one another and at least one of the intervening devices forms a data link with the defined device. Accordingly, the hop count can be indicative of a number of data links that are present between the device and the anchor device. As such, in some aspects, the hop count can be representative of a separation (logical, physical, or both) from a device in the data path group to the anchor device.

In some implementations, hop count between devices can be signaled—e.g., information indicative of the hop count can be transmitted—between devices associated with a data path group and can be retained (persistently or temporarily, for example) at each of such devices. In addition, each (or, in some embodiments, at least one) of the devices can include logic (e.g., machine-accessible instructions and/or data structures) that leverages the hop count for configuration of data path associated with the data path group. In some implementations, hop counts to a reference device, which may be referred to as an “anchor device,” within a data path group can be limited to a maximum hop count. Thus, incorporation of a device into the data path group can be permitted when determined that a hop count to anchor device does not exceed the maximum hop count. As such, the maximum hop count can provide a threshold to the expansion of the data path group. The anchor device for a data path group can be determined in numerous ways. In one example, the anchor device can be determined based at least on a defined or otherwise assigned rank within the data path group. In some implementations, a rank of a device can be determined using at least a number of existing data links of the device; a defined functionality or operational role of the device within a data path group (e.g., a multicast transmitter device can have higher rank); a random factor generated by a device; or a combination of the foregoing. In another example, a device that initiates or otherwise generates a data path group can be configured as the anchor device. In yet another example, a device that determines a base wake schedule for devices in the data path group can be configured as the anchor device. As further mentioned, in some embodiments, the data path group can be embodied in or can include a neighbor awareness networking (NAN) data cluster formed within (or, in some instances, logically on top of) a cluster of NAN devices.

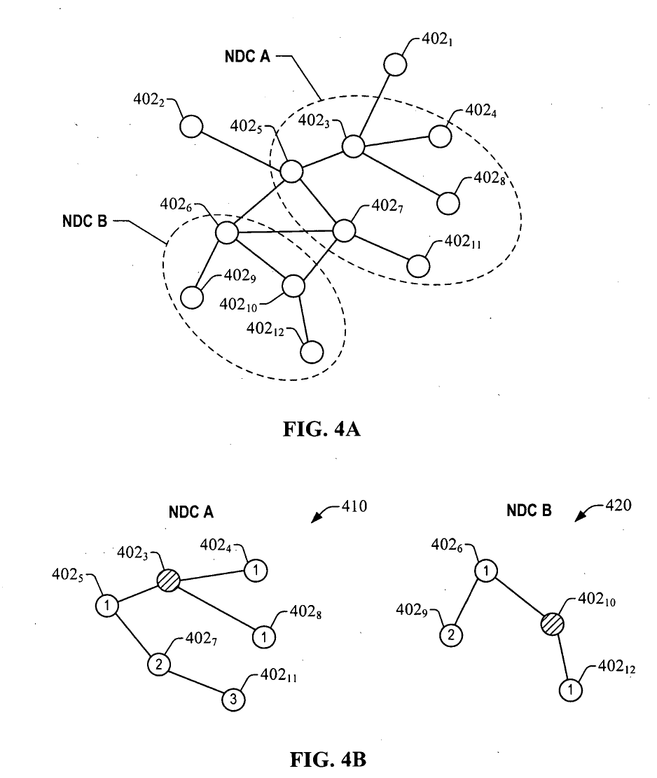

FIG. 4A illustrates an example of a cluster of devices 400 in which data path groups can be configured in accordance with one or more embodiments of this disclosure. Each (or, in some embodiments, at least one) of the devices in the cluster of devices 400 provide a specific functionality similarly to the devices in the example mesh network 320 illustrated in FIG. 3 hereinabove. In one example scenario, the cluster of device 400 can embody or can constitute at least a portion of the mesh network 320. In some implementations, the cluster of devices 400 can be embodied in a NAN cluster and, for the sake of illustration, the cluster of devices 400 can include twelve NAN devices: device 402₁, device 402₂, device 402₃, device 402₄, device 402₅, device 402₆, device 402₇, device 402₈, device 402₉, device 402₁₀, device 402₁₁, and device 402₁₂. As shown, the size of the cluster of devices 400 is M=12, corresponding to the twelve devices 402₁-402₁₂, and is sufficiently large for portions of the cluster to pertain to different NDCs. Specifically, the cluster of devices 400 can include, at least initially or at some instant, two NAN data clusters: A first NDC cluster (labeled as “NDC A”) including device 402₃, device 402₄, device 402₅, device 402₈, device 402₇, and device 402₁₁; and a second NDC cluster (labeled as “NDC B”) including devices 402₆, device 402₉, device 402₁₀, and device 402₁₂. In some aspects, each of the first NDC and second NDC can include an anchor device. For instance, device 402₃ can embody or can include the anchor device of the first cluster, and device 402₁₀ can embody or can include the anchor device of the second cluster. As an illustration, FIG. 4B presents the first and second NDCs in the cluster of devices 400, where anchor devices are shown as hatched circles and non-anchor-devices are shown as solid circles including a number representative of respective hop counts to the anchor device. Each (or, in some embodiments, at least one) of the devices in the cluster of devices 400 and associated data path groups (e.g., NAN data clusters) of in accordance with this disclosure can be embodied in or can include the device 510 illustrated in FIG. 5A described hereinafter.

FIG. 5A illustrates a block diagram of an example embodiment of a device 510 in accordance with one or more embodiments of the disclosure. The exemplified device 510 can operate in accordance with at least some aspects of the disclosure, configuring data path groups as described herein, for example. As mentioned, in some embodiments, the device 510 can embody or can constitute any one of the devices in the cluster of devices 400. Similarly, in other embodiments, the device 510 can embody or can constitute a device in a low-power mesh network, such as the example mesh network 320 in FIG. 3. As such, the device 510 can embody a border router device, a router device, a leader device, or a SED. In yet other embodiments, the device 510 can embody or can constitute the AP device 310 or any of the devices in the operational environment 100 shown in FIG. 1 or the operational environment 200 shown in FIG. 2. As such, in some aspects, the device 510 can provide one or more specific functionalities—such as operating as a digital camera and generating digital images (e.g., static pictures and/or motion pictures); operating as a navigation device; operating as a biometric device (e.g., a heart rate monitor, a pressure monitor, a glucometer, an iris analyzer, a fingerprint analyzer, etc.); dosing and delivering an amount of a drug or other compound; operating as a sensor and sensing a defined physical quantity, such as temperature and/or pressure, or motion; operating as another sensor and sensing a compound in gas phase or liquid phase; operating as a controller for configuring a second defined physical quantity, managing energy, managing access to an environment, managing illumination and/or sound, regulating a defined process, such an automation control process, or the like; generating current, voltage, or other type of signal via inductive coils; a combination of the foregoing; a derivative functionality of the foregoing; or the like. To that end, the device 510 can include one or more functionality units 522 (referred to as dedicated functionality unit 522) that can include optical elements (e.g., lenses, collimators, light guides, light sources, light detectors (such as semiconductor light detectors), focusing circuitry, etc.); temperature sensors; pressure sensors; gas sensors; motion sensors, including inertial sensors (such as linear accelerator and/or a gyroscope); mechanical actuators (such as locks, valves, and the like); a combination of the foregoing; or the like.

In addition or in other aspects, a specific functionality of the device 510 can be provided or otherwise implemented via one or more processors 524. In some implementations, at least one of the processor(s) 524 can be integrated with dedicated functionality unit 522. In some implementations, at least one of the processor(s) (e.g., one or more of the processor(s) 524 or other processor(s)) can receive and operate on data and/or other type of information (e.g., analog signals) generated by components of the dedicated functionality unit 522. The at least one processor can execute a module in order to operate on the data and/or other type of information and, as a result, provide a defined functionality. The module can be embodied in or can include, for example, a software application stored in a memory device integrated into or functionally coupled to the device. For instance, the module can be retained in one or more memory devices 532 (collectively referred to as dedicated functionality storage 532), where the dedicated functionality storage 532 can be retained within one or more other memory devices 530 (collectively referred to as device 530). In addition or in other implementations, at least a second one of the processor(s) (e.g., one or more of processor(s) 524 or other processor(s) available to the dedicated functionality unit 522) can control the operation or duty cycle of a portion of the dedicated functionality unit 522 so as to collect data and/or other type of information; provide an amount (or a dose) of a compound or acquire another amount of another compound or material; a combination of the foregoing; or the like. At least one of the units that constitute the dedicated functionality unit 522 can generate control signals (e.g., interruptions, alarms, or the like) and/or can direct or otherwise cause the device 510 to transition between operational states in response to a defined condition of the device 510 or its environment. At least some of the control signals can be sent to an external device (not depicted in FIG. 5A) via an I/O interface of the I/O interfaces 520. The type and/or number of components included in the dedicated functionality unit 522 can establish, at least in part, the complexity of the device 510. In some examples, the device 510 can embody or can constitute an AP device, and in other examples, the device 510 can embody or can constitute a SED or another type of IoT device.

The device 510 also can operate as a wireless device and can embody or can constitute an access point device, a mobile computing device (e.g., a station device or user equipment), or other types of communication devices that can transmit and/or receive wireless communications in accordance with this disclosure. In some aspects, to permit wireless operation—including the exchange of information associated with configuration of a data path group, as described herein—the device 510 includes a radio unit 514, a communication unit 526, and a data-path-group configuration unit 528. In some implementations, the communication unit 526 can generate packets and/or other types of information blocks via a network stack, for example, and can convey the packets and/or the other types of information blocks to the radio unit 514 for wireless communication. In one embodiment, the network stack (not shown) can be embodied in or can constitute a library or other types of programming modules, and the communication unit 526 can execute the network stack in order to generate a packet or other types of information block. Generation of the packet or the other types of information blocks can include, for example, generation of control information (e.g., checksum data, communication address(es)), traffic information (e.g., payload data), and/or formatting of such information into a specific packet header.

The data-path-group configuration unit 528 can perform or otherwise facilitate, at least in part, the configuration of a data path group in accordance with aspects of this disclosure, as described herein. To that end, in some embodiments, the data-path-group configuration 528 can include a number of components that can utilize or otherwise leverage information (e.g., data, metadata, and/or instructions) first information defining or otherwise specifying implementations of one or more mechanisms for setup and/or tear-down of a data path group and/or second information indicative of rules, records, or other data associated with such implementations in accordance with aspects of the disclosure. In some instances, the first information and the second information can be retained in one or more memory elements 534 (collectively referred to as data-path-group configuration information 534) within one or more memory devices 530 (collectively referred to as memory 530). In addition or in other instances, the first information and/or the second information can be retained within one or more other memory devices integrated into the data-path-group configuration unit 528. The data-path-group configuration unit 528 also can utilize or otherwise leverage, in other embodiments, the communication unit 526 in order to configure a data path group in accordance with aspects of this disclosure, as described herein.

As illustrated in FIG. 5A, the radio unit 514 can include one or more antennas 516 and a multi-mode communication processing unit 518. In some embodiments, the antenna(s) 516 can be embodied in or can include directional or omnidirectional antennas, including, for example, dipole antennas, monopole antennas, patch antennas, loop antennas, microstrip antennas or other types of antennas suitable for transmission of RF signals. In addition, or in other embodiments, at least some of the antenna(s) 516 can be physically separated to leverage spatial diversity and related different channel characteristics associated with such diversity. Further or in yet other embodiments, the multi-mode communication processing unit 518 that can process at least wireless signals in accordance with one or more radio technology protocols and/or modes (such as multiple-input multiple-output (MIMO), single-input-multiple-output (SIMO), multiple-input-single-output (MISO), and the like). Each of such protocol(s) can be configured to communicate (e.g., transmit, receive, or exchange) data, metadata, and/or signaling over a specific air interface. The one or more radio technology protocols can include, for example, 3GPP UMTS; LTE; LTE-A; Wi-Fi protocols, such as those of the Institute of Electrical and Electronics Engineers (IEEE) 802.11 family of standards; Worldwide Interoperability for Microwave Access (WiMAX); radio technologies and related protocols for ad hoc networks, such as Bluetooth® or ZigBee®; other protocols for packetized wireless communication; or the like). The multi-mode communication processing unit 418 also can process non-wireless signals (analogic, digital, a combination thereof, or the like).

In some embodiments, e.g., example embodiment 550 shown in FIG. 5B, the multi-mode communication processing unit 518 can comprise a set of one or more transmitters/receivers 554, and components therein (amplifiers, filters, analog-to-digital (A/D) converters, etc.), functionally coupled to a multiplexer/demultiplexer (mux/demux) unit 568, a modulator/demodulator (mod/demod) unit 566 (also referred to as modem 516), and a coder/decoder unit 512 (also referred to as codec 512). Each (or, in some instances, at least one) of the transmitter(s)/receiver(s) can form respective transceiver(s) that can transmit and receive wireless signal (e.g., electromagnetic radiation) via the one or more antennas 516. It is noted that in other embodiments, the multi-mode communication processing unit 518 can include, for example, other functional elements, such as one or more control units (e.g., a memory controller), an offload engine or unit, I/O interfaces, baseband processing circuitry, a combination of the foregoing, or the like. While illustrated as separate blocks in the device 510, it is noted that in some embodiments, at least a portion of the multi-mode communication processing unit 518, the communication unit 526, and/or data-path-group configuration unit can be integrated into a single unit—e.g., a single chipset or other type of solid state circuitry. In some aspects, such a single unit can be configured by programmed instructions retained in memory 530 and/or other memory devices integrated into or otherwise functionally coupled to the single unit.

Electronic components and associated circuitry, such as mux/demux unit 558, codec 562, and modem 566 can permit or otherwise facilitate processing and manipulation, e.g., coding/decoding, deciphering, and/or modulation/demodulation, of signal(s) received by the device 510 and signal(s) to be transmitted by the device 510. In some aspects, as described herein, received and transmitted wireless signals can be modulated and/or coded, or otherwise processed, in accordance with one or more radio technology protocols. Such radio technology protocol(s) can include, for example, 3GPP UMTS; 3GPP LTE; LTE-A; Wi-Fi protocols, such as IEEE 802.11 family of standards (IEEE 802.ac, IEEE 802.ax, and the like); IEEE 802.15.4; WiMAX; radio technologies and related protocols for ad hoc networks, such as Bluetooth® or ZigBee®; other protocols for packetized wireless communication; or the like.

The electronic components in the multi-mode communication processing unit 518, including the one or more transmitters/receivers 554, can exchange information (e.g., data, metadata, code instructions, signaling and related payload data, combinations thereof, or the like) through a bus 564, which can embody or can include at least one of a system bus, an address bus, a data bus, a message bus, a reference link or interface, a combination of the foregoing, or the like. Each (or, in some embodiments, at least one) of the one or more receivers/transmitters 554 can convert signal from analog to digital and vice versa. In addition or in the alternative, the receiver(s)/transmitter(s) 554 can divide a single data stream into multiple parallel data streams, or perform the reciprocal operation. Such operations may be conducted as part of various multiplexing schemes. As illustrated, the mux/demux unit 558 is functionally coupled to the one or more receivers/transmitters 554 and can permit processing of signals in time and frequency domain. In some aspects, the mux/demux unit 558 can multiplex and demultiplex information (e.g., data, metadata, and/or signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition or in the alternative, in another aspect, the mux/demux unit 558 can scramble and spread information (e.g., codes) according to most any code, such as Hadamard-Walsh codes, Baker codes, Kasami codes, polyphase codes, and the like. The modem 566 can modulate and demodulate information (e.g., data, metadata, signaling, or a combination thereof) according to various modulation techniques, such as frequency modulation (e.g., frequency-shift keying), amplitude modulation (e.g., M-ary quadrature amplitude modulation (QAM), with M a positive integer; amplitude-shift keying (ASK)), phase-shift keying (PSK), and the like). In addition, processor(s) that can be included in the device 510—e.g., processor(s) 524, or baseband processing circuitry or other type of computing circuitry included in the radio unit 514 or other functional element(s) of the device 510—can permit processing data (e.g., symbols, bits, or chips) for multiplexing/demultiplexing, modulation/demodulation (such as implementing direct and inverse fast Fourier transforms) selection of modulation rates, selection of data packet formats, inter-packet times, and the like.

The codec 562 can operate on information (e.g., data, metadata, signaling, or a combination thereof) in accordance with one or more coding/decoding schemes suitable for communication, at least in part, through the one or more transceivers formed from respective transmitter(s)/receiver(s) 554. In one aspect, such coding/decoding schemes, or related procedure(s), can be retained as computer-accessible instructions (computer-readable instructions, computer-executable instructions, or a combination thereof) in one or more memory devices 534 (collectively referred to as memory 434) and/or other memory device integrated into or otherwise functionally coupled to the radio unit 514. In a scenario in which wireless communication among the device 510 and another computing device (e.g., a station device, other types of user equipment, or customer premises equipment) utilizes MIMO, MISO, SIMO, or SISO operation, the codec 562 can implement at least one of space-time block coding (STBC) and associated decoding, or space-frequency block (SFBC) coding and associated decoding. In addition or in other scenarios, the codec 562 can extract information from data streams coded in accordance with spatial multiplexing scheme. In some aspects, to decode received information (e.g., data, metadata, signaling, or a combination thereof), the codec 562 can implement at least one of computation of log-likelihood ratios (LLR) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec 562 can utilize, at least in part, mux/demux unit 558 and mod/demod unit 566 to operate in accordance with aspects described herein.

With further reference to FIG. 5A, the device 510 can operate in a variety of wireless environments having wireless signals conveyed in different electromagnetic radiation (EM) frequency bands. To at least such end, the multi-mode communication processing unit 518 in accordance with aspects of the disclosure can process (code, decode, format, etc.) wireless signals within a set of one or more EM frequency bands (also referred to as frequency bands) comprising one or more of radio frequency (RF) portions of the EM spectrum, microwave portion(s) of the EM spectrum, or infrared (IR) portion(s) of the EM spectrum. In one aspect, the set of one or more frequency bands can include, for example, at least one of (i) all or most licensed EM frequency bands, (such as the industrial, scientific, and medical (ISM) bands, including the 2.4 GHz band or the 5 GHz bands); or (ii) all or most unlicensed frequency bands (such as the 60 GHz band) currently available for telecommunication.

As described herein, the device 510 can receive and/or transmit information encoded and/or modulated or otherwise processed in accordance with aspects of the present disclosure. To at least such an end, in some embodiments, the device 510 can acquire or otherwise access information wirelessly via the radio unit 514 (which also may be referred to as radio 514), where at least a portion of such information can be encoded and/or modulated in accordance with aspects described herein. Therefore, in some implementations, the memory 530 also can contain one or more memory elements having information suitable for processing information received according to a predetermined communication protocol (e.g., IEEE 802.11ac, IEEE 802.11ax, IEEE 802.15.4). While not shown, in some embodiments, one or more memory elements (e.g., registers, filed, databases, combinations thereof, or the like) of the memory 434 can include, for example, computer-accessible instructions that can be executed by one or more of the functional elements (units, components, circuitry, etc.) of the device 510 in order to implement at least some of the functionality for configuration of data path groups in a wireless network, in accordance with aspects described herein. One or more groups of such computer-accessible instructions can embody or can constitute a programming interface that can permit communication of information (e.g., data, metadata, and/or signaling) between functional elements of the device 510 for implementation of such functionality.

As further illustrated in FIG. 5A, the device 510 can include one or more I/O interfaces 520. At least one of the I/O interface(s) 520 can permit the exchange of information between the device 510 and another computing device and/or a storage device. Such an exchange can be wireless (e.g., via near field communication or optically-switched communication) or wireline. At least another one of the I/O interface(s) 520 can permit presenting information visually, aurally, and/or via movement to an end-user of the device 510. In one example, a haptic device can embody the I/O interface of the I/O interface(s) 520 that permit conveying information via movement. In addition, in the illustrated device 510, a bus architecture 536 (which also may be referred to as bus 536) can permit the exchange of information (e.g., data, metadata, and/or signaling) between two or more functional elements of the device 510. For instance, the bus 536 can permit exchange of information between two or more of (i) the radio unit 514 or a functional element therein, (ii) at least one of the I/O interface(s) 520, (iii) the communication unit 526, or (iv) the memory 534. In addition, one or more application programming interfaces (APIs) (not depicted in FIG. 5A) or other types of programming interfaces that can permit exchange of information (e.g., data and/or metadata) between two or more of the functional elements of the device 510. At least one of such API(s) can be retained or otherwise stored in the memory 534. In some embodiments, it is noted that at least one of the API(s) or other programming interfaces can permit the exchange of information within components of the communication unit 526. The bus 536 also can permit a similar exchange of information. In some embodiments, the bus 536 can embody or can include, for example, at least one of a system bus, an address bus, a data bus, a message bus, a reference link or interface, a combination thereof, or the like. In addition or in other embodiments, the bus 536 can include, for example, components for wireline and wireless communication.

It is noted that portions of the device 510 can embody or can constitute an apparatus. For instance, the multi-mode communication processing unit 518, the communication unit 526, the data-path-group configuration unit 528, and at least a portion of the memory 434 can embody or can constitute an apparatus that can operate in accordance with one or more aspects of this disclosure.

With further reference to FIG. 4A, in some aspects, each device of a data path group (e.g., an NDC) can retain information indicative of a hop count from the device to an anchor device of the data path group. At least a portion of the information can be retained, for example, in a memory device integrated into the device or functionality coupled thereto. As mentioned, such a hop count can be indicative of a number of data links that are present between the device and the anchor device. In an example scenario in which a data path group includes devices embodied in or including the device 510 illustrated in FIG. 5, the hop count information can be retained in data path group configuration information 534).

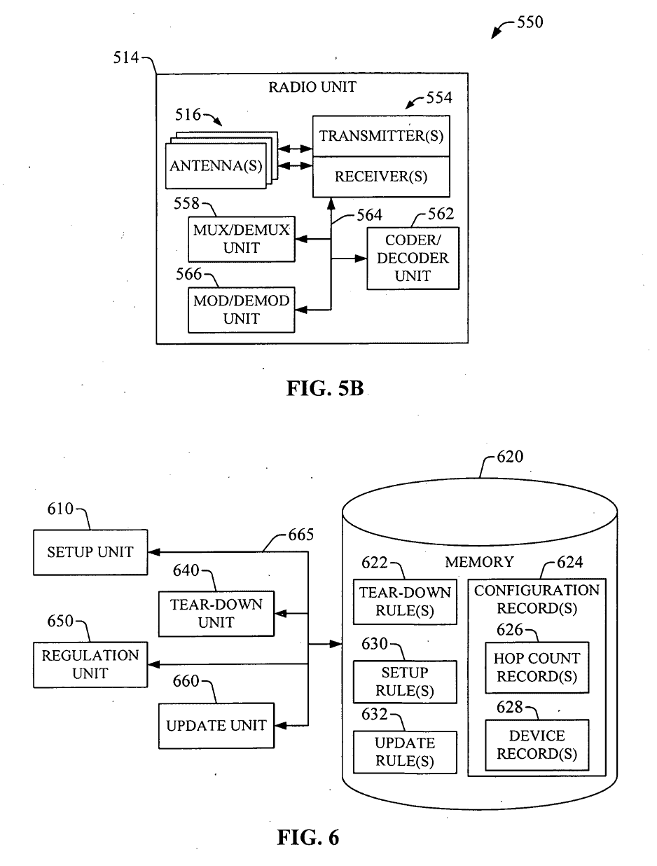

Hop count information can include, for example, first information indicative of hop count to an anchor device, second information indicative of a hop count threshold, and/or third information indicative of a maximum hop count for a data path group (e.g., an NDC). The hop information can be utilized or otherwise leveraged to configure a data path group. More specifically, during data path setup, for example, a device (e.g., a NAN device) can utilize hop count information to determine that a new NDC is to be created or that an existing NDC is to be joined. In some embodiments, the devices (e.g., the NAN devices) can have respective defined hop count threshold in order to avoid joining an existing data path group when it is ascertained that the hop count of the device, when added to the data path group, is greater than the defined hop count threshold. In some implementations, the hop count information can be retained in the data-path-group configuration info. 534 and the data-path-group configuration unit 528 can utilize or otherwise leverage at least a portion of such information to implement configured the data path group. As an illustration, the data-path-group configuration unit 528 can be embodied in the example apparatus 600 shown in FIG. 6. As shown, the example apparatus can include one or more memory devices 620 (collectively referred to as memory 620) that can include one or more memory elements 624 (collective referred to as configuration record(s) 624. In one aspect, the configuration record(s) 624 can include one or more hop count records 626, including a first record indicative of a defined hop count threshold of a device that includes the example apparatus 600. The hot count record(s) 626 also can include a second record indicative of a current hop count of the device. A regulation unit 650 can access the hop count record(s) 626 and determine whether a new NDC is to be created or an existing NDC is to be joined. In a scenario in which the regulation unit 650 ascertains that the current hop count of the device would exceed the hop count threshold, the regulation unit 650 can avoid joining an extant data path group. Such logic can be retained in one or more memory elements 630 (collective referred to as set rule(s) 630) having information indicative of one or more rules for configuration of a data path group.

In some aspects, a single member of the data path group (e.g., a particular device, such an anchor device) can establish the maximum hop count in the data path group. In some aspects, an entity that implements at least some of the functionality described herein can determine the maximum hop count of the device can be determined specifically. The entity can be embodied in or can include, for example, such as a human agent or a computerized agent (an autonomous or otherwise automated component). In one aspect, the entity (e.g., a device or a coordination component) can select or otherwise determine a value of the maximum hop count based at least on a tolerated capability and/or complexity of a data path group. For instance, such an entity can configure the maximum hop count to unity (1) in order to avoid potential multi-hop update. In addition or in another aspect, the maximum hop count may not be static and may be reconfigured as a function of time.

Configuration of a data path (or, in some instances, a data link) can include, in some aspects, the exchange of messages between a device that pertains to a data path group and another device that intends or otherwise can join the data path group. In one embodiment, a first device that attempts to join an existing data path group can send (e.g., broadcast, multicast, or unicast) an attachment message including information indicative of a request to join a data path group. For example, the first device can include a first data-path-group configuration unit embodied in an instance of the example apparatus 600, where information retained in the memory 620 can be specific to the first device. The setup unit 610 can execute the setup rule(s) 630 and, in response, can send the attachment message, which can include a broadcast frame, a multicast frame, or a unicast frame. A second device in the existing data path group can send (e.g., broadcast, multicast, or unicast) a message including a defined maximum hop count (N) and a current hop (n_{HC}) of the device in response to the attachment message. Here, N and n_{HC} are natural numbers. In addition or in other embodiments, the second device can send such a message at defined times (e.g., periodically or according to a defined schedule) without receiving the attachment message. The second device can include a second data-path-group configuration unit embodied in another instance of the example apparatus 600, where information retained in the memory 620 can be specific to the second device. The setup unit 610 associated with the second device can execute the setup rule(s) 630 and, in response, can send the first information indicative of N and second information indicative of n_{HC} in response to the attachment message.

Regardless of the mode in which the message that carries hop count information for the existing data path group is sent, the first device can receive the message and, using the defined threshold hop count, can determine that the attempt to attach to the data path group is to be terminated or that that the attempt is to be continued. Specifically, the first device can compare the defined threshold hop count N to n_{HC}+1 and terminate the attempt to attach to the data path group when an outcome of the comparison indicates n_{HC}+1>N. In the alternative, the second device can proceed with the attempt to attach to the data path group when n_{HC}+1≦N. As such, in one example, setup unit 610 associated with the first device can execute the setup rule(s) 630 and can determine that the attempt to attach to the data path group is to be terminated or continued based on the received N and n_{HC}. In a scenario in which the first device attaches to the existing data path group—e.g., a data link is added to the data group associated with the data path group—the second device can configure and retain a current hop count n′_{HC} of the first device as n_{HC}+1, and also can retain the defined maximum hop count. To that end, continuing with the foregoing example, an update unit 660 associated with the first device can execute one or more update rule(s) 632 and, in response, can configure and retain n′_{HC} within the hop count record(s) 626.

In addition or in some scenarios, rather than merging into an existing data path group, a new data path group (e.g., a new NDC) can be formed in response to formation of a data link between a first device and a second device. The device that initiates the formation of the data link (or the formation of the new data group) can be configured as the anchor device and the other device can configure a current hop count to be equal to unity. To at least such an end, a setup unit 610 of the device that initiates the formation of the data link can execute one or more of the setup rule(s) 630 and, in response, can configure the device as the anchor device. An update unit 660 can receive a signal indicative of such configuration and can generate and retain a record indicative of the device being the anchor device of the new data path group. Such a record can be retained within the configuration record(s) 624, in a memory element in the device record(s) 628. In addition, a second update unit 660 associated with the other, non-anchor device can execute one or more of second update rule(s) 632 and, in response, can configure the current hop count to unity. A record of such configuration can be created within the hop count record(s) 626. For instance, the first device can be embodied in the device 402₂ in path group of devices 400 in FIG. 4, and can initiate the formation of the data link, and thus can be configured as the anchor device. In addition, the second device can configure n_{HC}=1.

Further or in other scenarios, the first device and the second device can belong to an existing NDC (e.g., NDC A), and the NDL (NAN data link) can join the NDC. In this case, the first device and the second device can access a hop count of another device and can increase the hop count by one, resulting in a current hop count. Respective setup unit 610 and update unit 660 of the first and second devices can access and update the hop count. If the current hop count is smaller than an extant hop count, then the first device and/or the second device can update the hop count to a new value. Respective setup unit 610 and update unit 660 of the first and second devices can implement such logic, with the ensuing updates to hop count record(s) 626 of such devices. For example, as illustrated in diagram 410 in FIG. 4B, device 402₃ can be the anchor device for NDC A, and device 402₄ and device 402₈ pertain to NDC A, with anchor device 402₃. When 402₄ establishes a data link (e.g., an NDL) with 402₈, the established NDL can join the existing NDC A. Further, each of the device 402₄ and the device 402₈ can access the hop count of the other device and add 1, e.g., resulting in a hop count equal to 2. The value is not smaller than the existing hop count value stored in 402₄ and 402₈, i.e., 1. Hence, the existing hop count value is not updated. In response (e.g., upon or after) a device that pertains to an existing data path group (e.g., an existing NDC) updates the device's hop count to a current hop count n_{HC}, the device can send (e.g., broadcast, multicast, or unicast) information indicative of n_{HC} to the device(s) pertaining to the existing data path group with which the data link (e.g., a NAN data link) is established. The device can send the information upon or after (e.g., at a scheduled time) the data link is established. To that end, in one example, the update unit 660 associated with a data-path-configuration unit of the device can execute one or more of the update rule(s) 632 and, in response, the update unit 660 can direct a communication unit (e.g., unit 526) of the device to generate and transmit, via a radio unit, the information indicative of n_{HC}.

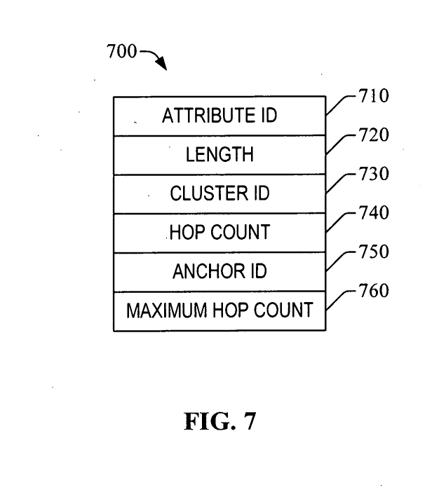

A device within a data path group can send a message that carries or otherwise conveys hop count information for the data path group. The hop count information can be included (e.g., encoded and/or transported), for example, in an attribute having data path group information. The attribute can be included, for example, in a service discovery frame or a NAN management frame. Thus, in some embodiments, such as the embodiment shown in FIG. 5, the device can include a communication unit 526 and a data-path-group configuration unit 528, where the data-path-group configuration unit 528 can send hop count information to the communication unit 526 which can configure (e.g., generate and/or format) the attribute and can encode it within the a frame, such as the NAN management frame or the service discovery frame. The communication unit 526 can utilize or otherwise leverage a radio unit 514, which also can be included in the device, to send (e.g., broadcast, multicast, or unicast) such a frame. As an illustration, in accordance with aspects of this disclosure, FIG. 7 illustrates an example of an attribute 700 that can convey the hop count information, including first information indicative of hop count for a device that provides (e.g., generates and/or send) the attribute. More specifically, the attribute 700 can include several fields (e.g., a first field, a second field, etc.) having respective size (e.g., a number of octets) and values (e.g., hexadecimal values), including an Attribute Identification (ID) 710 that can identifies a general data path group attribute (e.g., an NDC attribute). The attribute ID 710 can have a size of one octet and a variable value. The fields in the attribute 700 also can include a Length field 720 having a size of two octets and variable length, where the Length field 720 is indicative of the lengths of subsequent fields in the attribute 700. In addition, the fields in the attribute 700 can include a Cluster ID field 730 that identifies a data path group (e.g., an NDC) associated with the attribute 700. Further, the fields in the attribute 700 also can include a Hop Count field 740 indicative of a maximum hop count to the anchor device of the data path group associated with the attribute 700. The fields can further include an Anchor ID field 750 that identifies the anchor device of the data path group identified by the Cluster ID field 730. The fields in the attribute 700 also can include a Maximum Hop Count field 760 indicative of a maximum hop count permitted in the data path group identified by the Cluster ID field 730 or that is signaled by the anchor device.

In at least some embodiments, a device that pertains to a data path group (e.g., an NDC) can signal information (e.g., a list) indicative of NDCs that the device belongs to, and the device can signal the maximum hop count signaled by the anchor member of a NDC. Therefore, in some examples, the device can signal the anchor device of the NDC. Specifically, the device can send a frame (e.g., a broadcast frame, a multicast frame, or a unicast frame) including an attributed as described herein (see, e.g., FIG. 7 and related description).

As described herein, the configuration of a data path group in accordance with aspects of the disclosure can be regulated by defined rules, e.g., setup rules and/or tear-down rules. A device that pertains to a data path group or that can join the data path group can retain at least some of the rules. In one example, the device can include the data-path-group configuration info. 534 having the setup rules and/or the tear-down rules. In another example, the device can include the example apparatus 600, and the setup rules can be embodied in the setup rule(s) 630 and the tear-down rules can be embodied in the tear-down rule(s) 622. As mentioned, in some implementations, a setup rule for a device to join an existing data path group (e.g., an existing NDC) can include a comparison of a defined hop count threshold specific to the device with a corresponding hop count after the data path group is joined. In addition, the example setup rule can include termination or otherwise rejection of an attempt to join the data path group in response to an outcome of the comparison indicating that the corresponding hop count is greater than the defined hop count threshold. Further or in another example, the setup rule can include a maximum hop count and comparison of the corresponding hop count for a device after the data path group is joined with the maximum hop count. The setup rule can dictate termination of the an attempt to join the existing data path group in response to an outcome of the comparison indicating that the corresponding hop count of the device is greater than the maximum hop count. In some implementations, the maximum hop count can be signaled or otherwise transmitted by a member device of the existing path group, such as an anchor device (e.g., device 402₁₀ in NDC B in FIG. 4). It is noted that the defined hop count threshold can permit controlling the localized expansion of a data path group in the vicinity or from the perspective of a particular device joining the data path group, whereas the maximum hop count can permit controlling the overall expansion of the data path group from the perspective of a defined device of the data path group (such as an anchor device) in order to control data link topology.

In some scenarios, incorporation of a data link (e.g., a NAN data link) into a data path group can result in a device receiving a hop count update from other devices with which the device establishes the data link. In one example, the update can be embodied in or can include a message having an attribute such as example attribute 700 illustrated in FIG. 7 and described herein. The device can include, in one embodiment, the radio unit 514 and the communication device 526, where the radio unit 514 and the communication device 526 can receive information indicative of the hop count update. For instance, the communication device 526 can decode the information and can retain the hop count update in the data-path-group configuration info. 534 or the configuration record(s) 624. In response to the update, for example, the device can compare a current (or existing) hop count of the device with a new hop count equal to a hop count received in the update plus 1. The device can then update the current hop count to the new hop count when it ascertains that the new value is less than the current value. In addition or in other scenarios, the device can analyze the anchor device identified in the hop count update (e.g., in a message that embodies the hop count update). The analysis (e.g., a comparison and/or other types of operations yielding an outcome) can determine that the anchor device is different from a current anchor device associated with the device. In one embodiment, the device can include the example apparatus 600, where the update unit 660 can compare the current hop count and the new hop count and/or conduct the foregoing analysis. In response to ascertaining that the anchor device is different from the current anchor device, the device can select the greatest of (i) a first rank of the current anchor device associated with the device and (ii) a second rank of another anchor device associated with the sending device. If the first rank is greater than the second rank, then the device does not update the current hop count. In the alternative, if the first rank is less than the second rank, the device updates the current hop count to the signaled hop count plus 1.

As described herein, configuration of a data path group in accordance with aspects of the disclosure can include tear-down of a data path from an existing data path group. In at least some embodiments, data path tear down can utilize or otherwise leverage a record that identifies a device that updated a hop count as described herein. Specifically, a device that tears down a data link can compare a first data path group that the device pertains to with a second data path group identified in a hop count update. The second data path group can be identified in a field (e.g., Cluster ID field 730 in FIG. 7) of an attribute included in the hop count update (or a message that embodies the update). To that end, in one embodiment, the device can include the example apparatus 600 shown in FIG. 6, in which a tear-down unit 640 can perform such a comparison. For instance, the tear-down unit 640 can access a first record and a second record from the device record(s) 628. The first record can be indicative of the first data path group and the second record can be indicative of the second data path group. The tear-down unit 640 can then compare such records. Using an outcome of the comparison, the device can determine that the first data path group and the second data path group are different, and in response, the device can terminate the tear-down operation. In the foregoing embodiment, the tear-down unit 640 can terminate the tear-down operation. As described herein, the tear-down rule(s) 622 can include the described tear-down functionality. In a scenario in which an outcome of the comparison indicates that the first data path group is the same as the second data path group, the device can determine that the data link (e.g., an NDL) that is torn down (or otherwise removed from a data path group) is a data link with a second device that is different from that which is identified in the hop count update. An identifier (e.g., a device identification field) indicative or otherwise representative of a transmitter device can be accessed via a frame that includes the attribute. Therefore, in some aspects, the device can tear down the data link without updating its hop count. Continuing with reference to the foregoing embodiment, the tear-down unit 640 can perform such a determination and can tear down the data link as described. To such an end, in one example, the tear-down unit 640 can execute one or more of the tear-down rule(s) 622. In the alternative, the device can determine that the data link to be torn down is a data link with a second device that is the same as that which provided the hop count update. Thus, in response, the device can request (e.g., can transmit a request message or other type of signaling) that other device(s) with respective NDL(s) in the same NDC update their corresponding hop counts. As mentioned with respect to the foregoing embodiment, the tear-down unit 640 can perform such other determination and can send one or more messages conveying respective requests as described. To such an end, in one example, the tear-down unit 640 can execute one or more of the tear-down rule(s) 622. Further or in other embodiments, the device, via the setup unit 610 and/or the update unit 660, can configure itself as an anchor device, and can configure its current hop count to zero. Further or in yet other embodiments, message exchange and/or an assessment of rank in accordance with aspects described herein can be utilized to establish an anchor device in the remaining NDC without the removed NDL. Still with reference to the foregoing embodiment, the setup unit 610 and/or the update unit 660 can direct a communication unit 526 to send and/or receive such messages, and also can perform such an assessment. Further or in other embodiments, the device that tears down the data link can create a new NDC. As such, in the foregoing embodiment, the setup unit 610 can execute one or more of the setup rule(s) 630 in order to create the new data path group and update the device record(s) 628.

Various references to the example apparatus 600 illustrated in FIG. 6 are made in the present disclosure. As shown, a bus architecture 665 (also termed bus 665) can functionally couple (e.g., electrically couple, mechanically coupled, and/or communicatively couple) some or all of the functional elements (units, memory devices, etc.) of the example apparatus 600. The structure of the bus 628 can be or can constitute, in at least some embodiments, the structure of the bus 536 and/or the bus 564 described herein.

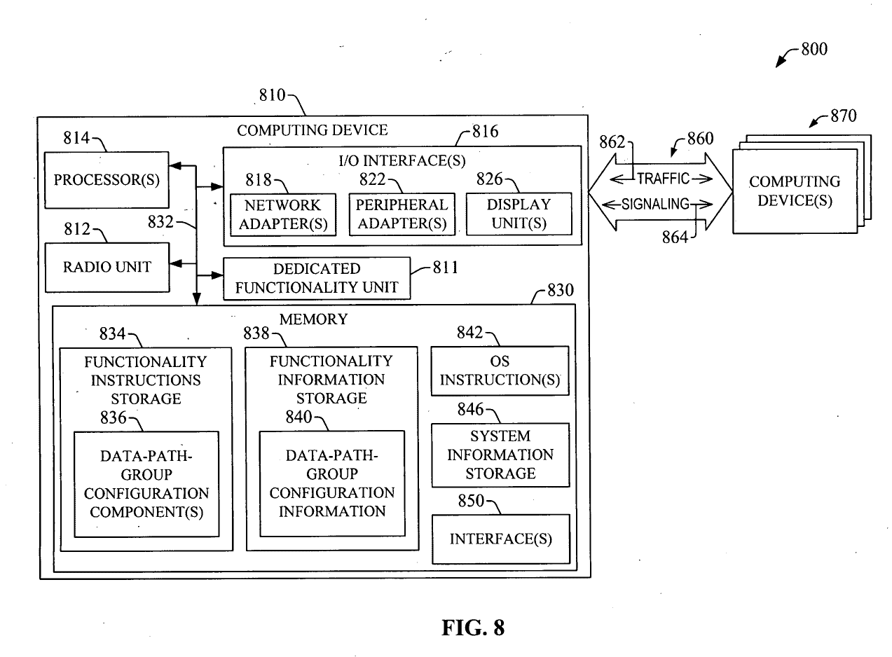

FIG. 8 presents an example of a computational environment 800 for wireless communication in accordance with one or more aspects of the disclosure. The example computational environment 800 is only illustrative and is not intended to suggest or otherwise convey any limitation as to the scope of use or functionality of such computational environments' architecture. In addition, the computational environment 800 should not be interpreted as having any dependency or requirement relating to any one or combination of components illustrated in this example computational environment. The illustrative computational environment 800 can embody or can include, for example, a device included in the example mesh network 320, one or more of the devices 116a or 116b, and/or any other computing device (e.g., device 410) that can implement or otherwise leverage the mechanisms for channel update and aspects thereof described herein. In some embodiments, the computing device 810 can embody or can include any one of the devices in a low-power mesh network, such as the example mesh network 320 in FIG. 3. As such, the device 710 can embody a border router device, a router device, a leader device, or a SED. In other embodiments, the computing device can embody or can constitute the AP device 310 or any of the devices in the operational environment 100 in FIG. 1 and/or the operational environment 300 shown in FIG. 3.

The computational environment 800 represents an example of a software implementation of the various aspects or features of the disclosure in which the processing or execution of operations described in connection with the mechanism for channel update for a communication channel of a sleepy end device in a thread network or other types of low-power networks, in accordance with aspects described herein can be performed in response to execution of one or more software components at the computing device 810. It is noted that the one or more software components can render the computing device 810, or any other computing device that contains such components, a particular machine for channel update for a communication channel of a sleepy end device in a thread network or other types of low-power networks, in accordance with aspects described herein, among other functional purposes. A software component can be embodied in or can comprise one or more computer-accessible instructions, e.g., computer-readable and/or computer-executable instructions. At least a portion of the computer-accessible instructions can embody one or more of the example techniques disclosed herein. For instance, to embody one such method, at least the portion of the computer-accessible instructions can be persisted (e.g., stored, made available, or stored and made available) in a computer storage non-transitory medium and executed by a processor. The one or more computer-accessible (or processor-accessible) instructions that embody a software component can be assembled into one or more program modules, for example, that can be compiled, linked, and/or executed at the computing device 810 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 810 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with mechanisms for channel update of communication channel of a sleepy end device can comprise personal computers; server computers; laptop devices; handheld computing devices, such as mobile tablets; wearable computing devices; and multiprocessor systems. Additional examples can include set top boxes, programmable consumer electronics, network PCs, minicomputers, mainframe computers, blade computers, programmable logic controllers, distributed computing environments that comprise any of the above systems or devices, and the like.

As illustrated, the computing device 810 can comprise one or more processors 814, one or more input/output (I/O) interfaces 816, a memory 830, and a bus architecture 832 (also termed bus 832) that functionally couples various functional elements of the computing device 810. As illustrated, the computing device 810 also can include a radio unit 812. In one example, similarly to the radio unit 514, the radio unit 812 can include one or more antennas and a communication processing unit that can permit wireless communication between the computing device 810 and another device, such as one of the computing device(s) 870. The computing device 810 also can include, in at least some embodiments, a dedicated functionality unit 811 that can provide specific functionality to the computing device 810, similarly to the dedicated functionality unit 522 described hereinbefore. As such, the structure and at least some of the functional elements of the dedicated functionality unit 911 can be similar to those of the dedicated functionality 522. The bus 832 can include at least one of a system bus, a memory bus, an address bus, or a message bus, and can permit exchange of information (data, metadata, and/or signaling) between the processor(s) 814, the I/O interface(s) 816, and/or the memory 830, or respective functional element therein. In some scenarios, the bus 832 in conjunction with one or more internal programming interfaces 850 (also referred to as interface(s) 850) can permit such exchange of information. In scenarios in which processor(s) 814 include multiple processors, the computing device 810 can utilize parallel computing.

The I/O interface(s) 816 can permit or otherwise facilitate communication of information between the computing device and an external device, such as another computing device, e.g., a network element or an end-user device. Such communication can include direct communication or indirect communication, such as exchange of information between the computing device 810 and the external device via a network or elements thereof. As illustrated, the I/O interface(s) 816 can comprise one or more of network adapter(s) 818, peripheral adapter(s) 822, and display unit(s) 826. Such adapter(s) can permit or facilitate connectivity between the external device and one or more of the processor(s) 814 or the memory 830. In one aspect, at least one of the network adapter(s) 818 can couple functionally the computing device 810 to one or more computing devices 870 via one or more traffic and signaling links 860 that can permit or facilitate exchange of traffic 862 and signaling 864 between the computing device 810 and the one or more computing devices 870. Such network coupling provided at least in part by the at least one of the network adapter(s) 818 can be implemented in a wired environment, a wireless environment, or both. Therefore, it is noted that in some embodiments, the functionality of the radio unit 812 can be provided by a combination of at least one of the network adapter(s) 818 and at least one of the processor(s) 814. Accordingly, in such embodiments, the radio unit 812 may not be included in the computing device 810. The information that is communicated by the at least one network adapter can result from implementation of one or more operations in a method of the disclosure. Such output can be any form of visual representation, including, but not limited to, textual, graphical, animation, audio, tactile, and the like. In some scenarios, each of the computing device(s) 870 can have substantially the same architecture as the computing device 810. In addition or in the alternative, the display unit(s) 826 can include functional elements (e.g., lights, such as light-emitting diodes; a display, such as liquid crystal display (LCD), combinations thereof, or the like) that can permit control of the operation of the computing device 810, or can permit conveying or revealing operational conditions of the computing device 810.

In one aspect, the bus 832 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, Universal Serial Bus (USB), and the like. The bus 832, and all buses described herein can be implemented over a wired or wireless network connection and each of the subsystems, including the processor(s) 814, the memory 830 and memory elements therein, and the I/O interface(s) 816 can be contained within one or more remote computing devices 870 at physically separate locations, connected through buses of this form, in effect implementing a fully distributed system.

The computing device 810 can comprise a variety of computer-readable media. Computer readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 810, and can comprise, for example, both volatile and non-volatile media, and removable and/or non-removable media. In one aspect, the memory 830 can comprise computer-readable media in the form of volatile memory, such as random access memory (RAM), and/or non-volatile memory, such as read only memory (ROM).

The memory 830 can comprise functionality instructions storage 834 and functionality information storage 838. The functionality instructions storage 834 can comprise computer-accessible instructions that, in response to execution (by at least one of the processor(s) 814), can implement one or more of the functionalities of the disclosure. The computer-accessible instructions can embody or can comprise one or more software components illustrated as data-path-group configuration component(s) 836. In one scenario, execution of at least one component of the data-path-group configuration component(s) 836 can implement one or more of the techniques disclosed herein. For instance, such execution can direct or otherwise cause a processor that executes the at least one component to carry out a disclosed example method. It is noted that, in one aspect, a processor of the processor(s) 814 that executes at least one of the data-path-group configuration component(s) 836 can retrieve information from or retain information in a memory element 840 in the functionality information storage 838 in order to operate in accordance with the functionality programmed or otherwise configured by the data-path-group configuration component(s) 836. Such information can include at least one of code instructions, information structures, or the like. At least one of the one or more interfaces 850 (e.g., application programming interface(s)) can permit or facilitate communication of information between two or more components within the functionality instructions storage 834. The information that is communicated by the at least one interface can result from implementation of one or more operations in a method of the disclosure. In some embodiments, one or more of the functionality instructions storage 834 and the functionality information storage 838 can be embodied in or can comprise removable/non-removable, and/or volatile/non-volatile computer storage media.

At least a portion of at least one of the data-path-group configuration component(s) 836 or data-path-group configuration information 840 can program or otherwise configure one or more of the processors 814 to operate at least in accordance with the functionality described herein. One or more of the processor(s) 814 can execute at least one of such components and leverage at least a portion of the information in the storage 838 in order to provide mechanisms for channel update for a communication channel Of a sleepy end device in a thread network or other types of low-power networks (wireless or otherwise), in accordance with one or more aspects described herein. More specifically, yet not exclusively, in some implementations, execution of one or more of the component(s) 836 can permit transmitting and/or receiving information at the computing device 810, where the at least a portion of the information can permit or otherwise facilitate the configuration of a data path group in accordance with aspects of this disclosure. As such, it is noted that in some embodiments, a combination of the processor(s) 814, the data-path-group configuration component(s) 836, and the data-path-group configuration information 840 can form means for providing specific functionality for mechanism for channel update for a communication channel of a sleepy end device in a thread network or other types of low-power networks, in accordance with one or more aspects of the disclosure.

In some scenarios, the functionality instruction(s) storage 834 can embody or can comprise a computer-readable non-transitory storage medium having computer-accessible instructions that, in response to execution, direct or otherwise cause at least one processor (e.g., one or more of processor(s) 814) to perform a group of operations comprising the operations or blocks described in connection with the disclosed techniques for updating a communication channel of a device in a low-power mesh network in accordance with this disclosure.

In addition, the memory 830 can comprise computer-accessible instructions and information (e.g., data and/or metadata) that permit or facilitate operation and/or administration (e.g., upgrades, software installation, any other configuration, or the like) of the computing device 810. Accordingly, as illustrated, the memory 830 can comprise a memory element 842 (labeled OS instruction(s) 842) that contains one or more program modules that embody or include one or more OSs, such as Windows operating system, Unix, Linux, Symbian, Android, Chromium, and substantially any OS suitable for mobile computing devices or tethered computing devices. In one aspect, the operational and/or architecture complexity of the computing device 810 can dictate a suitable OS. The memory 830 also comprises a system information storage 846 having data and/or metadata that permits or facilitate operation and/or administration of the computing device 810. Elements of the OS instruction(s) 842 and the system information storage 846 can be accessible or can be operated on by at least one of the processor(s) 814.

It should be recognized that while the functionality instructions storage 834 and other executable program components, such as the operating system instruction(s) 842, are illustrated herein as discrete blocks, such software components can reside at various times in different memory components of the computing device 810, and can be executed by at least one of the processor(s) 814. In some scenarios, an implementation of the data-path-group configuration component(s) 836 can be retained on or transmitted across some form of computer readable media.

The computing device 810 and/or one of the computing device(s) 870 can include a power supply (not shown), which can power up components or functional elements within such devices. The power supply can be a rechargeable power supply, e.g., a rechargeable battery, and it can include one or more transformers to achieve a power level suitable for operation of the computing device 810 and/or one of the computing device(s) 870, and components, functional elements, and related circuitry therein. In some scenarios, the power supply can be attached to a conventional power grid to recharge and ensure that such devices can be operational. In one aspect, the power supply can include an I/O interface (e.g., one of the network adapter(s) 818) to connect operationally to the conventional power grid. In another aspect, the power supply can include an energy conversion component, such as a solar panel, to provide additional or alternative power resources or autonomy for the computing device 810 and/or one of the computing device(s) 870.

The computing device 810 can operate in a networked environment by utilizing connections to one or more remote computing devices 870. As an illustration, a remote computing device can be a personal computer, a portable computer, a server device, a router device, a network computer, a peer device or other common network node, and so on. As described herein, connections (physical and/or logical) between the computing device 810 and a computing device of the one or more remote computing devices 870 can be made via one or more traffic and signaling link 860, which can comprise wireline link(s) and/or wireless link(s) and several network elements (such as router devices or switch devices, concentrator devices, server devices, and the like) that form a PAN, a LAN, a WAN, a WPAN, a WLAN, and/or a WWAN. Such networking environments are conventional and commonplace in dwellings, offices, enterprise-wide computer networks, intranets, local area networks, and wide area networks.

It is noted that, in at least some embodiments, portions of the computing device 810 can embody or can constitute an apparatus. For instance, at least one of the processor(s) 814; at least a portion of the memory 830, including a portion of the data-path-group configuration component(s) 836 and a portion of the data-path-group configuration information 840; and at least a portion of the bus 832 can embody or can constitute an apparatus that can operate in accordance with one or more aspects of this disclosure.

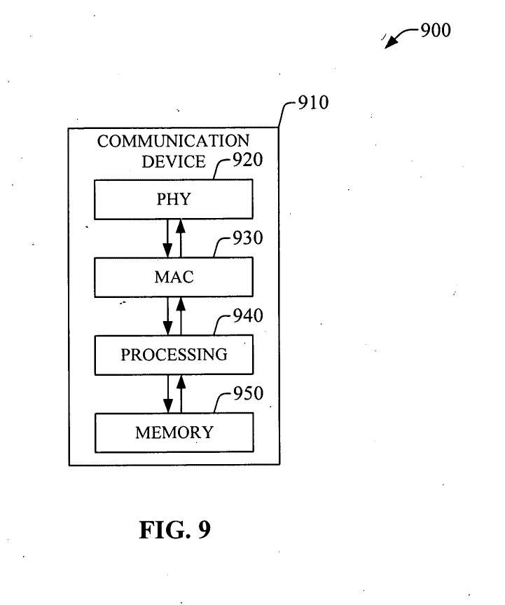

FIG. 9 presents another example embodiment of a device 910 in accordance with one or more embodiments of the disclosure. The device 910 can embody or can constitute, for example, one of the communication devices 110a, 110b, or 110c; one or more of the base stations 114a, 114b, or 114c; and/or any other devices (e.g., device 510) that can implement or otherwise leverage configuration of data path groups in accordance with aspects described herein. In some embodiments, the device 910 can embody or can constitute any one of the devices in a low-power mesh network, such as the example mesh network 320 shown in FIG. 3. As such, the device 910 can embody a border router device, a router device, a leader device, or a SED. In addition or other embodiments, the device 910 can embody or can constitute any of the devices in the example cluster of device 400 shown in FIG. 4A. Therefore, in some implementations, the device 710 can be a device compliant with IEEE 802.15.4, Thread, and/or NAN protocols, where the device may be configured to communicate with one or more other similarly compliant devices and/or other types of communication devices, such as legacy communication devices. In addition or in other embodiments, the device 910 can be compliant with Wi-Fi protocols and/or Thread protocols. Devices compliant with IEEE 802.15.4 and/or Thread protocols may be broadly referred to as Thread devices and can operate in accordance with aspects described herein. As mentioned, Thread devices, such as border router devices, also may operate in accordance with Wi-Fi protocols. In one implementation, the device 910 can operate as a commissioner device, a border router device, a leader device, a router device, or a SED.

As illustrated, the device 910 can include, among other things, physical layer (PHY) circuitry 920 and media access control layer (MAC) circuitry 930. In one aspect, the PHY circuitry 920 and the MAC circuitry 930 can be layers compliant with IEEE 802.15.4 and/or Thread protocols, and also can be compliant, in some embodiments, with one or more Wi-Fi protocols, such as one or more of NAN protocols and/or or protocol(s) of the family of IEEE 802.11 standards. In one aspect, the MAC circuitry 930 can be arranged to configure physical layer converge protocol (PLCP) protocol data units (PPDUs) and arranged to transmit and receive PPDUs, among other things. In addition or in other embodiments, the device 910 also can include other hardware processing circuitry 940 (e.g., one or more processors) and one or more memory devices 950 (which can be collectively referred to as memory 950) configured to perform the various operations for configuration of data path groups as described herein.

In some embodiments, the MAC circuitry 730 can be arranged to contend for a wireless medium during a contention period to receive control of the medium for a control period and configure a PPDU. In addition or in other embodiments, the PHY circuitry 920 can be arranged to transmit the PPDU. The PHY circuitry 920 can include circuitry for modulation/demodulation, upconversion/downconversion, filtering, amplification, etc. As such, the device 910 can include a transceiver to transmit and receive data such as PPDU. In some embodiments, the hardware processing circuitry 940 can include one or more processors. The hardware processing circuitry 940 can be configured to perform functions based on instructions being stored in a memory device (e.g., volatile random access memory (RAM), non-volatile RAM, or read only memory (ROM)) or based on special purpose circuitry. In some embodiments, the hardware processing circuitry 940 can be configured to perform one or more of the functions described herein, such as allocating bandwidth or receiving allocations of bandwidth.

In some embodiments, one or more antennas may be coupled to or included in the PHY circuitry 920. The antenna(s) can transmit and receive wireless signals, including transmission of HEW packets or other type of radio packets. As described herein, the one or more antennas can include one or more directional or omnidirectional antennas, including dipole antennas, monopole antennas, patch antennas, loop antennas, microstrip antennas or other types of antennas suitable for transmission of RF signals. In scenarios in which MIMO communication is utilized, the antennas may be physically separated to leverage spatial diversity and the different channel characteristics that may result.

The memory 950 can retain or otherwise store information for configuring the other circuitry to perform operations for configuring and transmitting packets compliant with Thread protocols and/or other types of radio packets, and performing the various operations described herein including, for example, configuring a data path group in accordance with one or more embodiments of this disclosure. The memory 950 can include any type of memory devices, including non-transitory storage media, for storing information in a form readable by a machine (e.g., a computer or another type of computing device). As an illustration, the memory 950 can include at least one computer-readable storage device, such as ROM device(s), RAM device(s), magnetic disk storage media, optical storage media, flash-memory device(s), and other storage devices and media.

The device 910 can be configured to communicate using OFDM communication signals over a multicarrier communication channel. More specifically, in some embodiments, the device 910 can be configured to communicate in accordance with one or more specific radio technology protocols, such as the IEEE family of standards including IEEE 802.11, IEEE 802.11n, IEEE 802.11ac, IEEE 802.11ax, IEEE 802.15.4, DensiFi, and/or proposed specifications for WLANs. In one of such embodiments, the device 910 can utilize or otherwise rely on symbols having a duration that is four times the symbol duration of IEEE 802.11n and/or IEEE 802.11ac. It is noted that the disclosure is not limited in this respect and, in some embodiments, the device 910 also can transmit and/or receive wireless communications in accordance with other protocols and/or standards.

The device 910 can be embodied in or can constitute a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as IEEE 802.11, IEEE 802.15.4, or IEEE 802.16; or other types of communication device that may receive and/or transmit information wirelessly. Similarly to the computing device 810, the device 910 can include, for example, one or more of a keyboard, a display, a non-volatile memory port, multiple antennas, a graphics processor, an application processor, speakers, and other mobile device elements. The display may be an LCD screen including a touch screen.

It is noted that while the device 910 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating or otherwise executing on one or more processors. It is further noted that portions of the device 910 can embody or can constitute an apparatus. For instance, the processing circuitry 940 and the memory 950 can embody or can constitute an apparatus that can operate in accordance with one or more aspects of this disclosure. The apparatus also can include functional elements (e.g., a bus architecture and/or API(s) as described herein) that can permit exchange of information between the processing circuitry 940 and the memory 950.

As used in the present specification and annexed drawings, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

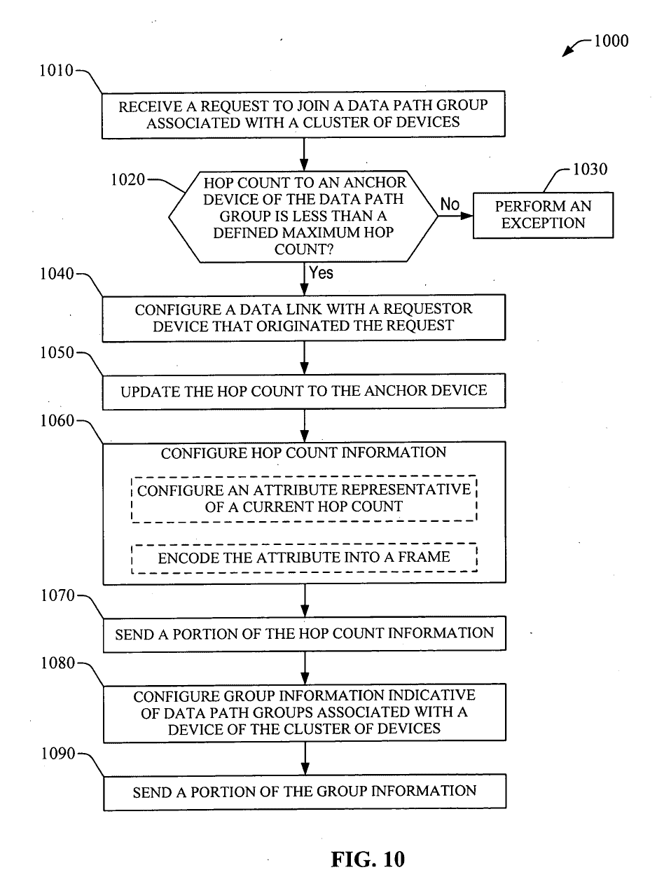

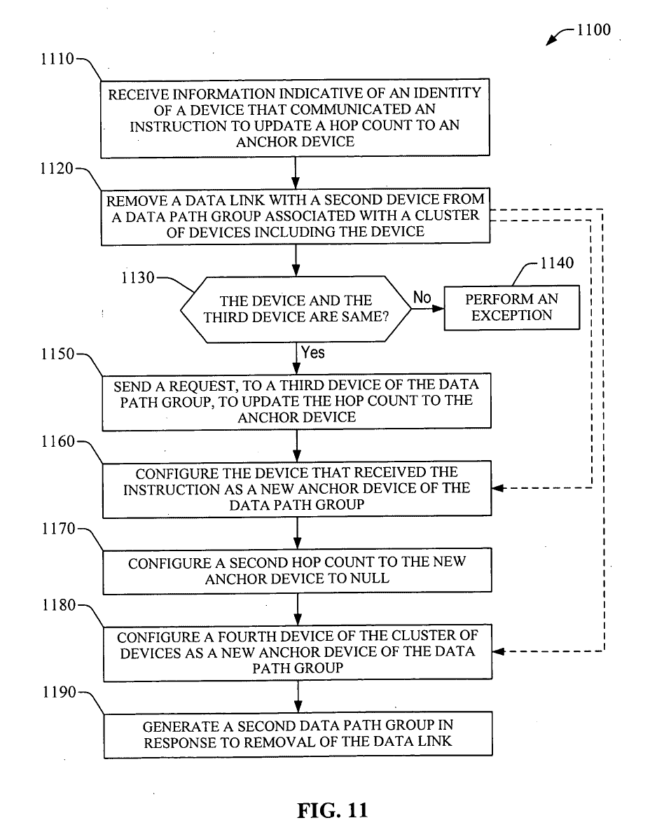

In view of the functionalities described herein in accordance with this disclosure, various techniques can be implemented for configuring data path groups associated with a cluster of devices that can communicate wirelessly and can operate according to a specific communication protocol (e.g., a IEEE 802.11 standardized protocol). Example of such techniques can be better appreciated with reference, for example, to the flowcharts in FIGS. 10-11. For purposes of simplicity of explanation, the example method disclosed herein is presented and described as a series of blocks (with each block representing one or more actions or operations, for example). However, it is to be understood and appreciated that the illustrated method is not limited by the order of blocks and associated actions or operations, as some blocks may occur in different orders and/or concurrently with other blocks from those that are shown and described herein. For example, the various methods (or processes or techniques) in accordance with this disclosure can be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes, or functionalities described herein in connection with adaptive mid-packet detection, can be implemented in combination with each other in order to accomplish one or more of the elements or advantages of this disclosure.

It is noted that the techniques of this disclosure can be retained on an article of manufacture, or computer-readable medium, to permit or facilitate transporting and transferring such methods to a computing device (e.g., a desktop computer; a mobile computer, such as a tablet, or a smartphone; a gaming console, a mobile telephone; a blade computer; a programmable logic controller, and the like) for execution, and thus implementation, by a processor of the computing device or for storage in a memory thereof or functionally coupled thereto. In one aspect, one or more processors, such as processor(s) that implement (e.g., execute) one or more of the disclosed techniques, can be employed to execute code instructions retained in a memory, or any computer- or machine-readable medium, to implement the one or more methods. The code instructions can provide a computer-executable or machine-executable framework to implement the techniques described herein.

FIG. 10 presents an example method 1000 for setting up a data link in a data path group according to one or more embodiments of the disclosure. At block 1010, a request to join a data path group associated with a cluster of devices can be received. A device of the cluster of devices can receive the request from a requestor device. In some scenarios, the requestor device can be included in the cluster of devices. At block 1020, it can be determined if a hop count from the requestor device to an anchor device of the data path group is less than a defined maximum hop count. In response to ascertaining that the hop count is greater than the maximum′ hop count, an exception can be performed at 1030. In the alternative, in response to ascertaining that such a hop count is less than the defined maximum hop count, a data link can be configured with the requestor device at block 1040. As mentioned, the requestor device can originate the request. At block 1050, in response to configuration of the data link, the device that received the request can update the hop count to the anchor device. At block 1060, the device can configure hop information in accordance with aspects described herein. In some embodiments, configuring the hop count information can include configuring an attribute representative of a current hop count. In addition or in other embodiments, configuring the hop count information can include encoding the attribute into a communication frame, such as a NAN management frame or a service frame. Regardless of the particular manner of configuring the hop count information, the device can send (e.g., broadcast, multicast, or unicast) a portion of the hop count information at block 1070. At block 1080, the device can configure group information indicative of data path groups associated with the device and, at block 1090, the device can send a portion of the group information.

FIG. 11 presents an example method 1100 for tearing down a data path link associated with a data path group according to one or more embodiments of the disclosure. The data path group can be configured according, at least in part, to the example method 1000 described hereinabove. At block 1110, a device can receive information indicative of an identity of a second device that communicated an instruction to update a hop count to an anchor device. At block 1120, the device can remove a data link with a third device from a data path group associated with a cluster of devices including the device. At block 1130, the device can determine if the second device and the third device are the same. In response to ascertaining that the second device and the third device are not the same, the device can perform an exception at block 1140. In the alternative, in response to ascertaining that the second device and the third device are the same, the device can send a request, to a fourth device of the data path group, for example, to update the hop count to the anchor device at block 1150. At block 1160, the device can configure itself as a new anchor device of the data path group and, at block 1170, the device can configure a second hop count to the new anchor device to null. At block 1180, a fourth device of the device of the cluster of devices can be configured as a new anchor device of the data path group. At block 1190, the device (or, in some embodiments, another device) can generate a second data path group. It is noted that in some embodiments, as illustrated with dashed-lined arrows, one or more blocks can be performed as alternative to other block(s).

In view of the numerous aspects of the disclosure, an example embodiment of the disclosure can include a device. The device may comprise at least one memory device having programmed instructions; and at least one processor configured to access the at least one memory device, and further configured to execute the instructions to: receive a request to join a data path group associated with a cluster of devices including the device; determine that a hop count to an anchor device of the data path group is less than a defined maximum hop count; and configure a data link with a requestor device that originated the request. The maximum hop count can determine, for example, a spatial arrangement of devices that can be configured in the data path group. In some aspects, to configure the data link with the requestor device, the at least one processor is further configured to generate the data path group; to configure the device as the anchor device; and to direct the requestor device to update a second hop count, and wherein information indicative of the second hop count is retained at the requestor device. In addition or in other aspects, the device can include a radio unit coupled to the at least one processor, and to configure the data link with the requestor device, the at least one processor can be further configured to direct the radio unit to send information indicative of the hop count to the requestor device; and to direct the radio unit to send, to the requestor device, an instruction to update a second hop count to the anchor device, and further wherein second information indicative of the second hop count is retained at the requestor device. In addition or in other aspects, the at least one processor can be further configured to execute the instructions to direct the device to send information indicative of data path groups associated with clusters of devices including the device. Further or in yet other aspects, the at least one processor is further configured to execute the instructions to direct the device to send at least one of the defined maximum hop count or information indicative of the anchor device.

Some implementation may include one or more of the following elements. The at least one processor can be further configured to execute the instructions to update the hop count to the anchor device in response to configuration of the data link, resulting at least in a current hop count to the anchor device. When configuring the data link with the requestor device, the device may further configure the at least one processor to generate the data path group, configure the device as the anchor device, and direct the requestor device to update a second hop count, wherein information indicative of the second hop count is retained at the requestor device. The device may also configure the at least one processor to: send information indicative of the hop count to the requestor device and direct the requestor device to update a second hop count to the anchor device, and wherein information indicative of the second hop count is retained at the requestor device.

In addition or in the alternative, the at least one processor can be further configured to execute the instructions to configure an attributive representative of the current hop count and to encode the attribute into one of a neighbor awareness networking (NAN) service discovery frame or a NAN management frame. To configure the attribute, the at least one processor is further configured to execute the instructions to configure at least one of a first field indicative of the current hop count, a second field indicative of the anchor device, or a third field indicative of the defined maximum hop count. Further or in other aspects, the at least one processor is further configured to direct the radio unit to send one of the NAN service discovery frame or the NAN management frame, send information indicative of data path groups associated with clusters of devices including the device, send at least one of the defined maximum hop count or information indicative of the anchor device. In some implementations, the device can include a radio unit configured to transmit wireless signals, and further configured to receive second wireless signals, wherein the radio unit is functionally coupled to the at least one processor. The radio may comprise a transceiver to generate the wireless signals, and further configured to receive the second wireless signals, and at least one antenna functionally coupled to the transceiver device. The data path group of the device can include a neighbor awareness networking (NAN) data cluster.

According to example embodiments of the disclosure, there may be a device. The device may comprise at least one memory device having programmed instructions; and at least one processor configured to access the at least one memory device, and further configured to execute the instructions to: receive information indicative of an identity of a second device that communicated an instruction to update a hop count to an anchor device; remove a data link with a third device from a data path group associated with a cluster of devices including the device; and in response to removal of the data link, determine that the second device and the third device are same, and send a request, to a fourth device of the data path group, to update the hop count to the anchor device.

Implementation may include one or more of the following elements. The device, in response to removal of the data link, may configure the at least one processor to further execute instructions to: configure the device as a new anchor device of data path group and to configure a second hop count to the new anchor device as null or configure a fifth device of the devices as a new anchor device of the data path group using at least one of defined messages exchanged between the devices of the new data cluster or a defined rank of the devices. The device may configure the at least one processor to generate a second path data group in response to removal of the data link.

According to example embodiments of the disclosure, there may be at least one computer-readable storage device. The at least one computer-readable storage device may have instructions encoded thereon that, in response to execution, direct a device to perform or facilitate operations comprising: receiving a request to join a data path group associated with a cluster of devices including the device; determining that a hop count to an anchor device of the data path group is less than a defined maximum hop count; and configuring a data link with a requestor device that originated the request.

Implementation may include one or more of the following elements. Execution of the instructions retained in the at least one computer-readable storage device can direct or otherwise facilitate the device to perform operations comprising updating the hop count to the anchor device in response to configuration of the data link, resulting at least in a current hop count to the anchor device. In some aspects, configuring the data link with the requestor device can include generating the data path group; configuring the device as the anchor device; directing the requestor device to update a second hop count; and directing the requestor device to retain information indicative of the second hop count. In addition or in the alternative, execution of the instructions retained in the computer-readable storage device can direct or otherwise facilitate the device to perform operations comprising: sending information indicative of the hop count to the requestor device and directing the requestor device to update a second hop count to the anchor device, and wherein information indicative of the second hop count is retained at the requestor device. Further or in some examples, execution of the instructions retained in the computer-readable storage device can direct the device to perform or otherwise facilitate operations including configuring an attributive representative of the current hop count and encoding the attribute into one of a neighbor awareness networking (NAN) service discovery frame or a NAN management frame. In some implementations, configuring the attribute can include configuring at least one of a first field indicative of the current hop count, a second field indicative of the anchor device, or a third field indicative of the defined maximum hop count. Execution of the instructions retained in the computer-readable storage device can further direct the device to perform or facilitate operations comprising sending one of the NAN service discovery frame or the NAN management frame, sending information indicative of data path groups associated with clusters of devices including the device, and/or sending, at least one of the defined maximum hop count or information indicative of the anchor device. The data path group of the storage device may comprise a neighbor awareness networking (NAN) data cluster.

According to example embodiments of the disclosure, there may be a method. The method may perform operations comprising: receiving a request to join a data path group associated with a cluster of devices including the device; determining that a hop count to an anchor device of the data path group is less than a defined maximum hop count; and configuring a data link with a requestor device that originated the request.

Implementation may include one or more of the following elements. The method may perform operations comprising updating the hop count to the anchor device in response to configuration of the data link, resulting at least in a current hop count to the anchor device. When configuring the data link with the requester device, the method may perform operations comprising: generating the data path group, configuring the device as the anchor device, and directing the requestor device to update a second hop count, wherein information indicative of the second hop count is retained at the requestor device. The method may also perform operations comprising: sending information indicative of the hop count to the requestor device and directing the requestor device to update a second hop count to the anchor device, and wherein information indicative of the second hop count is retained at the requestor device. The method may perform operations comprising: configuring an attributive representative of the current hop count and encoding the attribute into one of a neighbor awareness networking (NAN) service discovery frame or a NAN management frame. To configure the attribute, the method may perform operations comprising at least one of a first field indicative of the current hop count, a second field indicative of the anchor device, or a third field indicative of the defined maximum hop count. The method may perform operations comprising: sending one of the NAN service discovery frame or the NAN management frame, sending information indicative of data path groups associated with clusters of devices including the device, sending at least one of the defined maximum hop count or information indicative of the anchor device. The data path group of the method may comprise a neighbor awareness networking (NAN) data cluster.

According to example embodiments of the disclosure, there may be an apparatus. The apparatus may perform operations comprising: means for receiving a request to join a data path group associated with a cluster of devices including the device; means for determining that a hop count to an anchor device of the data path group is less than a defined maximum hop count; and means for configuring a data link with a requestor device that originated the request.

Implementation may include one or more of the following features. The apparatus may perform operations comprising means for updating the hop count to the anchor device in response to configuration of the data link, resulting at least in a current hop count to the anchor device. When configuring the data link with the requester device, the apparatus may perform operations comprising: means for generating the data path group, means for configuring the device as the anchor device, and means for directing the requestor device to update a second hop count, wherein information indicative of the second hop count is retained at the requestor device. The apparatus may also perform operations comprising: means for sending information indicative of the hop count to the requestor device and means for directing the requestor device to update a second hop count to the anchor device, and wherein information indicative of the second hop count is retained at the requestor device. The apparatus may perform operations comprising: means for configuring an attributive representative of the current hop count and encoding the attribute into one of a neighbor awareness networking (NAN) service discovery frame or a NAN management frame. To configure the attribute, the apparatus may perform operations comprising at least one of a first field indicative of the current hop count, a second field indicative of the anchor device, or a third field indicative of the defined maximum hop count. The apparatus may perform operations comprising: means for sending one of the NAN service discovery frame or the NAN management frame, means for sending information indicative of data path groups associated with clusters of devices including the device, means for sending at least one of the defined maximum hop count or information indicative of the anchor device. The data path group of the apparatus may comprise a neighbor awareness networking (NAN) data cluster

According to example embodiments of the disclosure, there may be at least one computer-readable storage device. The at least one computer-readable storage device may have instruction encoded thereon that, in response to execution, direct a device to perform or otherwise facilitate operations comprising: receiving information indicative of an identity of a second device that communicated an instruction to update a hop count to an anchor device; removing a data link with a third device from a data path group associated with a cluster of devices including the device; and in response to removal of the data link, determining that the second device and the third device are same, and sending a request, to a fourth device of the data path group, to update the hop count to the anchor device.

In some implementations, execution of the instructions retained in the at least one computer-readable storage device may direct a device, in response to removal of the data link, to perform or otherwise facilitate operations comprising: configuring the device as a new anchor device of data path group and configuring a second hop count to the new anchor device as null or configuring a fifth device of the devices as a new anchor device of the data path group using at least one of defined messages exchanged between the devices of the new data cluster or a defined rank of the devices. In addition or in other implementations, execution of the instructions retained in the computer-readable storage device can direct the device to perform or otherwise facilitate operations comprising generating a second path data group in response to removal of the data link.

According to example embodiments of the disclosure, there may a method. The method may perform operations comprising: receiving information indicative of an identity of a second device that communicated an instruction to update a hop count to an anchor device; removing a data link with a third device from a data path group associated with a cluster of devices including the device; and in response to removal of the data link, determining that the second device and the third device are same, and sending a request, to a fourth device of the data path group, to update the hop count to the anchor device.

Implementation may include one or more of the following elements. The method may, in response to removal of the data link, perform operations comprising: configuring the device as a new anchor device of data path group and configuring a second hop count to the new anchor device as null or configuring a fifth device of the devices as a new anchor device of the data path group using at least one of defined messages exchanged between the devices of the new data cluster or a defined rank of the devices. The method may perform operations comprising generating a second path data group in response to removal of the data link.

Implementation may include one or more of the following elements. The method may, in response to removal of the data link, perform operations comprising: configuring the device as a new anchor device of data path group and configuring a second hop count to the new anchor device as null or configuring a fifth device of the devices as a new anchor device of the data path group using at least one of defined messages exchanged between the devices of the new data cluster or a defined rank of the devices. The method may perform operations comprising generating a second path data group in response to removal of the data link.

According to example embodiments of the disclosure, there may be an apparatus. The apparatus may perform operations comprising: means for receiving information indicative of an identity of a second device that communicated an instruction to update a hop count to an anchor device; means for removing a data link with a third device from a data path group associated with a cluster of devices including the device; and in response to removal of the data link, means for determining that the second device and the third device are same, and means for sending a request, to a fourth device of the data path group, to update the hop count to the anchor device.

Implementation may include one or more of the following elements. The apparatus may, in response to removal of the data link, perform operations comprising: means for configuring the device as a new anchor device of data path group and means for configuring a second hop count to the new anchor device as null or means for configuring a fifth device of the devices as a new anchor device of the data path group using at least one of defined messages exchanged between the devices of the new data cluster or a defined rank of the devices. The apparatus may perform operations comprising means for generating a second path data group in response to removal of the data link.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include ROM device(s); RAM device(s); magnetic disk storage media; optical storage media; flash memory device(s); resistive memory device(s); etc.

Embodiments of the operational environments and techniques (procedures, methods, processes, and the like) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, special purpose computer, or other programmable information processing apparatus to produce a particular machine, such that the operations or functions specified in the flowchart block or blocks can be implemented in response to execution at the computer or processing apparatus.

Blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “system,” “architecture,” “interface,” “unit,” “module,” “engine,” “platform,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confers at least in part the functionality of the electronic components. An interface can include input/output (I/O) components as well as associated processor, application, and/or other programming components. The terms “component,” “environment,” “system,” “architecture,” “interface,” “unit,” “engine,” “platform,” “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a reduced instruction set computing (RISC) microprocessor, a discrete gate or transistor logic, discrete hardware components, or any combination thereof designed to perform the functions described herein. A processor can be implemented as a combination of computing processing units. In certain embodiments, processors can utilize nanoscale architectures, such as molecular and quantum-dot based transistors, switches and gates, in order to optimize space usage or enhance performance of user equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, a non-volatile memory device can include ROM device, programmable ROM (PROM) device, electrically programmable ROM (EPROM) device, electrically erasable ROM (EEPROM) device, non-volatile RAM, and/or silicon-oxide-nitride-oxide-silicon (SONOS) device. As an illustration, NVRAM devices can be embodied in several forms, including flash memory devices and/or a resistive memory devices, such as magnetoresistive RAM (MRAM) devices, phase change RAM (PRAM) devices, and/or conductive bridge RAM (CBRAM)) devices. A volatile memory device can include RAM, which can act as an external cache memory device. By way of illustration and not limitation, RAM can be available in many forms, such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more impleinentations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that can permit or otherwise facilitate configuration (e.g., can provide mechanisms to configure or otherwise establish) of data path groups in a low-power network (wireless or otherwise). It is, of course, not possible to describe every conceivable combination of elements and/or methods for purposes of describing the various elements of the disclosure, but it can be recognized that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. A device, comprising:
at least one memory device having programmed instructions; and
at least one processor configured to access the at least one memory device, and further configured to execute the instructions to:
receive a request to join a data path group associated with a cluster of devices including the device;
determine that a hop count to an anchor device of the data path group is less than a defined maximum hop count; and
configure a data link with a requestor device that originated the request.

2. The device of claim 1, wherein the at least one processor is further configured to execute the instructions to update the hop count to the anchor device in response to configuration of the data link, resulting at least in a current hop count to the anchor device.

3. The device of claim 1, wherein to configure the data link with the requestor device, the at least one processor is further configured to generate the data path group;
to configure the device as the anchor device; and
to direct the requestor device to update a second hop count, and wherein information indicative of the second hop count is retained at the requestor device.

4. The device of claim 2, further comprising a radio unit coupled to the at least one processor, and wherein to configure the data link with the requestor device, the at least one processor is further configured to direct the radio unit to send information indicative of the hop count to the requestor device; and
to direct the radio unit to send, to the requestor device, an instruction to update a second hop count to the anchor device, and further wherein second information indicative of the second hop count is retained at the requestor device.

5. The device of claim 4, wherein the at least one processor is further configured to execute the instructions to configure an attribute representative of the current hop count, and further comprising a communication unit configured to encode the attribute into one of a neighbor awareness networking (NAN) service discovery frame or a NAN management frame.

6. The device of claim 5, wherein to configure the attribute, the at least one processor is further configured to execute the instructions to configure at least one of a first field indicative of the current hop count, a second field indicative of the anchor device, or a third field indicative of the defined maximum hop count.

7. The device of claim 5, wherein the at least one processor is further configured to direct the radio unit to send one of the NAN service discovery frame or the NAN management frame.

8. The device of claim 1, wherein the at least one processor is further configured to execute the instructions to direct the device to send information indicative of data path groups associated with clusters of devices including the device.

9. The device of claim 1, wherein the at least one processor is further configured to execute the instructions to direct the device to send at least one of the defined maximum hop count or information indicative of the anchor device.

10. The device of claim 1, wherein the maximum hop count determines a spatial arrangement of devices that can be configured in the data path group.

11. The device of claim 2, wherein the radio unit is further configured to transmit wireless signals, and further configured to receive second wireless signals.

12. The device of claim 11, wherein the radio unit comprises a transceiver to generate the wireless signals, and further configured to receive the second wireless signals, and
at least one antenna functionally coupled to the transceiver device.

13. The device of claim 1, wherein the data path group comprises a neighbor awareness networking (NAN) data cluster.

14. A device, comprising:
at least one memory device having programmed instructions; and
at least one processor configured to access the at least one memory device, and further configured to execute the instructions to:
receive information indicative of an identity of a second device that communicated an instruction to update a hop count to an anchor device;
remove a data link with a third device from a data path group associated with a cluster of devices including the device; and
in response to removal of the data link, determine that the second device and the third device are same, and
send a request, to a fourth device of the data path group, to update the hop count to the anchor device.

15. The device of claim 14, wherein in response to removal of the data link, the at least one processor is further configured to execute the instructions to configure the device as a new anchor device of the data path group; and
to configure a second hop count to the new anchor device to null.

16. The device of claim 14, wherein in response to removal of the data link, the at least one processor is further configured to execute the instructions to configure a fifth device of the devices as a new anchor device of the data path group.

17. The device of claim 14, wherein the at least one processor is further configured to execute the instructions to generate a second data path group in response to removal of the data link.

18. At least one computer-readable storage device having instruction encoded thereon that, in response to execution, direct a device to perform or facilitate operations comprising:
receiving a request to join a data path group associated with a cluster of devices including the device;
determining that a hop count to an anchor device of the data path group is less than a defined maximum hop count; and
configuring a data link with a requestor device that originated the request.

19. The at least one computer-readable storage device of claim 18, wherein the operations further comprise updating the hop count to the anchor device in response to the configuring, wherein the updating results at least in a current hop count to the anchor device.

20. The at least one computer-readable storage device of claim 18, wherein the configuring the data link with the requestor device comprises generating the data path group;
configuring the device as the anchor device;
directing the requestor device to update a second hop count; and
directing the requestor device to retain information indicative of the second hop count.

21. The at least one computer-readable storage device of claim 19, wherein configuring the data link with the requestor device comprises sending information indicative of the hop count to the requestor device;
directing the requestor device to update, a second hop count to the anchor device; and
directing the requestor device to retain information indicative of the second hop count.

22. The at least one computer-readable storage of claim 21, further comprising configuring an attribute representative of the current hop count; and
encoding the attribute into one of a neighbor awareness networking (NAN) service discovery frame or a NAN management frame.

23. The at least one computer-readable storage device of claim 18, wherein the operations further comprise sending information indicative of data path groups associated with clusters of devices including the device.

24. The at least one computer-readable storage device of claim 18, wherein the operations further comprise sending at least one of the defined maximum hop count or information indicative of the anchor device.
